(19) United States
(12) Patent Application Publication
(10) Pub. No.: US 2004/0073476 A1
(43) Pub. Date: Apr. 15, 2004

(54) Method and system for identifying key opinion leaders

(75) Inventors: Derek Donahue, Centreville, VA (US); Bonnie Rishell Kotz, Vienna, VA (US); Robert Matthew Curran, Haymarket, VA (US); Archibald Anderson, Highland, NY (US); Herbert Kotz, Potomac, MD (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Prolink Services LLC, Vienna, VA

(21) Appl. No.: 10/394,165

(22) Filed: Mar. 24, 2003

Related U.S. Application Data
(60) Provisional application No. 60/417,158, filed on Oct. 10, 2002.

(51) Int. Cl. G06F 17/60

(52) U.S. Cl. 705/10

(57) ABSTRACT

A system and method for automated opinion leader surveying are provided. In at least one embodiment, survey respondents are enabled to provide opinion leader information to an automated system. The automated system preferably includes a system adapted to support a website through which the survey respondents can provide their opinion leader information. The system is further adapted to generate one or more reports based in part on information received from the respondents. The report(s) can include one or more lists, maps, graphs, charts and the like that may be utilized to identify opinion leaders and/or particular characteristics associated with the opinion leaders, such as geographical concentration, relationships between opinion leaders, and the like. The survey and/or the presentation of the report(s) can be conducted over a network via a website. The present invention finds particular benefit in identifying opinion leaders among medical practitioners.

### CROSS-REFERENCE TO RELATED APPLICATIONS

Priority is claimed based on U.S. Provisional Application No. 60/417,158 entitled “Method and System for Identifying Key Opinion Leaders”, filed Oct. 10, 2002.

### FIELD OF THE INVENTION

The present invention relates generally to conducting surveys to identify opinion leaders and more particularly to automating the process of determining key opinion leaders.

### BACKGROUND OF THE INVENTION

Certain medical practitioners are recognized as individuals whose opinions are highly regarded by others within their field of practice. These “opinion leaders” often are invited to give speeches, submit articles to medical journals, or otherwise provide their knowledge and experience with others within their specialty. As such, their opinions regarding a certain drug or other pharmaceutical often have a considerable impact on the sales of that drug.

Pharmaceutical manufactures typically prefer to develop relationships with the opinion leaders rather than focusing marketing efforts on a large subset of the practitioners in a given field. The expenses involved in marketing a drug often are substantially proportional to the number of practitioners included in the sales pitch. These expenses can include dinners, conferences, and/or vacation packages for the practitioners; visits to doctor's offices by pharmaceutical representatives; the distribution of free samples, and the like. By minimizing the number of practitioners approached, a pharmaceutical manufacturer can significantly reduce the marketing costs associated with a drug. Further, by focusing on opinion leaders, pharmaceutical manufacturers often use the opinion leaders' respected status in their respective medical fields to further promote their products.

Due to the potential cost savings resulting from focused marketing efforts on opinion leaders, pharmaceutical manufacturers spend considerable resources trying to identify the opinion leaders in a given medical field. One common method includes utilizing research specialists to analyze journal articles and press articles, attend conferences and industry meetings, or otherwise perform research to identify those practitioners who may be opinion leaders. Another common method includes determining opinion leaders by mail or telephone surveys. In this approach, a pharmaceutical manufacturer or its associate generates a list of practitioners in a particular medical field. The pharmaceutical manufacturer or associate then mails a survey to some or all of these listed practitioners. The mailed survey often relays a request for the practitioner to identify a number of local and national practitioners with whom the surveyed practitioner converses or has monitored by attending conferences where an identified practitioner spoke, reading articles written by an identified practitioner, and the like. The surveyed practitioners provide this information on the survey and then mail or fax the survey back to the pharmaceutical manufacturer or its associate. The received survey information typically is manually tallied by one or more data entry specialists. The tallied information is used to generate a master spreadsheet of practitioners along with one or more “scores” assigned to each practitioner. The score associated with a listed practitioner typically includes a representation of the number of surveyed practitioners who have identified the listed practitioner as a national and/or regional opinion leader. The marketing component (e.g., the pharmaceutical representatives) of the pharmaceutical manufacturer then use this spreadsheet to identify those listed practitioners who are “opinion leaders” based on their scores.

This method, however, has a number of limitations. For one, it often requires a considerable amount of manual exertion in preparing and mailing surveys, receiving the returned surveys, tallying the survey information, generating the lists of practitioners, and the like. Furthermore, the end result—the “scored” practitioner spreadsheet—often is of limited utility in determining opinion leaders since the format of the spreadsheet generally is static and requires considerable effort to change the format. Further, pharmaceutical representatives may have difficulty in gaining a comprehensive understanding of the relationships between practitioners simply by viewing the spreadsheet, especially when the spreadsheet is extensive. As such, the pharmaceutical representatives may fail to identify some or all of the “key opinion leaders” whose opinions are especially well regarded by those practitioners in their field and whose opinions and activities with relation to a particular drug can ensure the failure or the success of the drug.

Accordingly, an improved technique for identifying opinion leaders would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In accordance with one embodiment of the present invention, a method for obtaining opinion leader information is provided. The method comprises the steps of providing an opinion leader survey to a plurality of survey participants, receiving a survey response from each of a subset of the survey participants, the survey response identifying one or more opinion leaders, and generating at least one report based in part on the survey responses, the at least one opinion leader report including a hierarchical format.

In accordance with another embodiment of the present invention, a method for obtaining opinion leader information via a network is provided. The method comprises the steps of providing a website for access by a plurality of survey participants via a network, the website including at least one web page representing an opinion leader survey, receiving a survey response from each of a subset of the survey participants via the at least one web page of the website, the survey response including information identifying one or more opinion leaders, and generating at least one opinion leader report based in part on the survey responses received via the website.

In accordance with yet another embodiment of the present invention, a method for providing survey response information is provided. The method comprises the steps of generating at least one report based in part on survey responses received from a plurality of survey participants, each survey response including information identifying one or more opinion leaders from a perspective of the corresponding survey participant, and providing the at least one report for display on at least one web page of a website.

In accordance with an additional embodiment of the present invention, a system for automated opinion leader surveying is provided. The system comprises a database and a data server operably connected to the database and being adapted to provide, to a plurality of survey participants, data for display as at least one web page, the at least one web page representing an opinion leader survey and receive, via the at least one displayed web page, a survey response from each of a subset of the survey participants, the survey response including information identifying one or more opinion leaders. The system further comprises a response management module operably connected to the database and the data server and being adapted to store a representation of each survey response in the database and a report generation module operably connected to the database and being adapted to generate at least one report based in part on the stored representations of the survey responses.

In accordance with another embodiment of the present invention, a system for automated opinion leader surveying using a network is provided. The system comprises a report generation module being adapted to generate at least one report based in part on at least one survey responses to an opinion leader survey, the survey response including information identifying at least one opinion leader and a data server operably connected to the report generation module and being adapted to provide, to at least one report recipient, data for display as at least one web page, the at least one web page representing the at least one report.

In accordance with yet another embodiment of the present invention, a computer readable medium is provided. The computer readable medium comprises a set of instructions being adapted to manipulate a processor to provide a website for access by a plurality of survey participants via a network, the website including at least one web page representing an opinion leader survey, receive a survey response from each of a subset of the survey participants via the at least one web page of the website, the survey response including information identifying one or more opinion leaders, and generate at least one opinion leader report based in part on the survey responses received via the website.

In accordance with an additional embodiment of the present invention, a computer readable medium is provided. The computer readable medium comprises a set of instructions being adapted to manipulate a processor to generate at least one report based in part on survey responses received from a plurality of survey participants of an opinion leader survey, each survey response including information identifying one or more opinion leaders from a perspective of the corresponding survey participant and provide the at least one report for display on at least one web page of a website.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary system for automated surveying of practitioners to identify opinion leaders in accordance with at least one embodiment of the present invention.

FIG. 2 is a flow diagram illustrating an exemplary method for automated surveying of practitioners to identify opinion leaders in accordance with at least one embodiment of the present invention.

FIG. 3 is a schematic diagram illustrating an exemplary system for surveying practitioners via a website in accordance with at least one embodiment of the present invention.

FIG. 4 is a block diagram illustrating an exemplary website map for the website of FIG. 3 in accordance with at least one embodiment of the present invention.

FIG. 5 is a block diagram illustrating an exemplary web page of the website of FIG. 3 for obtaining personal information from a surveyed practitioner in accordance with at least one embodiment of the present invention.

FIG. 6 is a block diagram illustrating an exemplary web page of the website of FIG. 3 for obtaining regional opinion leader information from a surveyed practitioner in accordance with at least one embodiment of the present invention.

FIG. 7 is a block diagram illustrating an exemplary web page of the website of FIG. 3 for obtaining national opinion leader information from a surveyed practitioner in accordance with at least one embodiment of the present invention.

FIG. 8 is a block diagram illustrating an exemplary web page of the website of FIG. 3 for obtaining personal information of an opinion leader identified by a surveyed practitioner in accordance with at least one embodiment of the present invention.

FIG. 9 is a flow diagram illustrating an exemplary method for automated surveying of practitioners via the website of FIG. 3 in accordance with at least one embodiment of the present invention.

FIG. 10 is a schematic diagram illustrating an exemplary system for automated storage and modification of practitioner information in accordance with at least one embodiment of the present invention.

FIG. 11 is a schematic diagram illustrating an exemplary system for providing survey results information to a pharmaceutical representative via a website in accordance with at least one embodiment of the present invention.

FIG. 12 is a block diagram illustrating an exemplary web page of the website of FIG. 11 for obtaining opinion leader search parameters from a pharmaceutical representative in accordance with at least one embodiment of the present invention.

FIG. 13 is a block diagram illustrating an exemplary spreadsheet of survey results in accordance with at least one embodiment of the present invention.

FIG. 14 is a block diagram illustrating an exemplary relationship graph in accordance with at least one embodiment of the present invention.

FIG. 15 is a block diagram illustrating an exemplary opinion leader map in accordance with at least one embodiment of the present invention.

FIG. 16 is a schematic diagram illustrating an exemplary implementation of the system of FIG. 1 in greater detail in accordance with at least one embodiment of the present invention.

FIGS. 17-27 are block diagrams illustrating exemplary web pages of a community portal website implementing online opinion leader surveying in accordance with at least one embodiment of the present invention.

### DETAILED DESCRIPTION OF THE INVENTION

The following description is intended to convey a thorough understanding of the present invention by providing a number of specific embodiments and details involving conducting surveys to identify opinion leaders. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

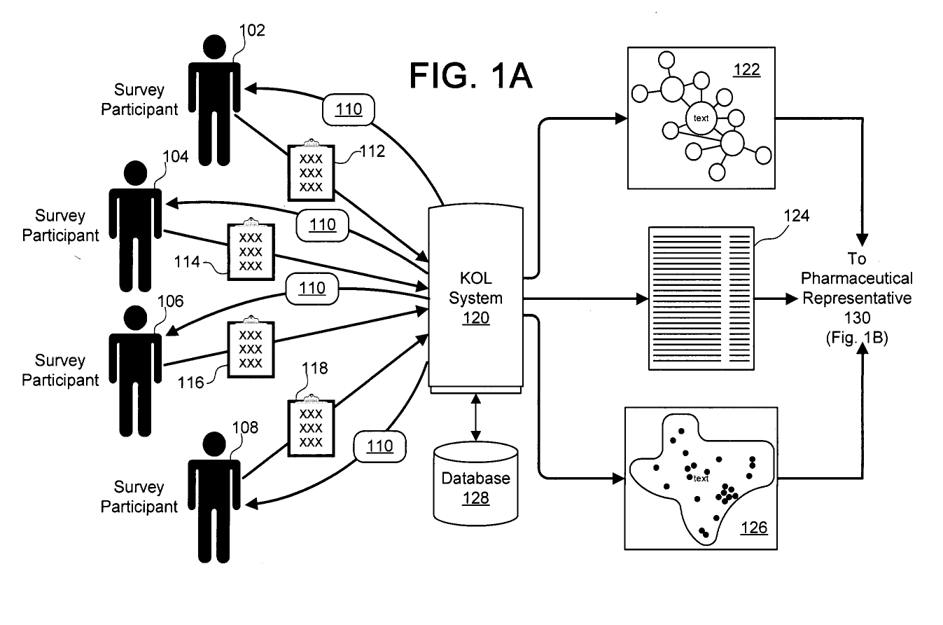

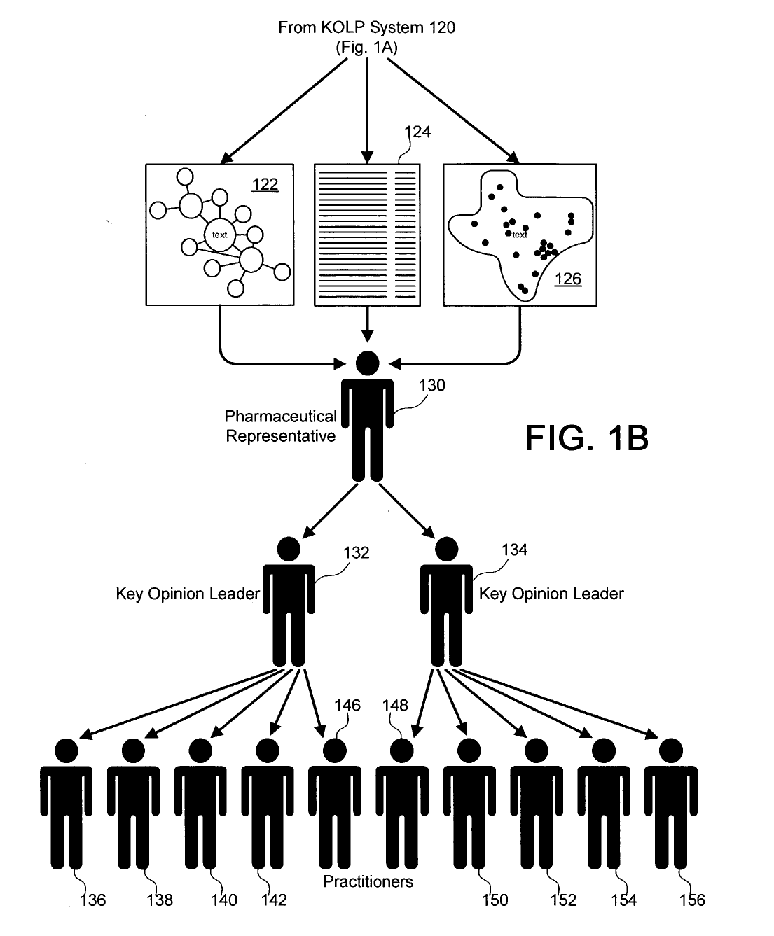

FIGS. 1-27 illustrate an exemplary system and method for automated surveying of respondents with regard to opinion leaders. In at least one embodiment, survey respondents are enabled to provide opinion leader information to an automated system. The automated system preferably includes a system adapted to support a website through which the survey respondents can identify opinion leaders in their given field. The system is further adapted to generate one or more reports based in part on information received from the respondents. The report(s) can include one or more lists, maps, graphs, charts and the like that may be utilized to identify opinion leaders and/or particular characteristics associated with the opinion leaders, such as geographical concentration, relationships between opinion leaders, and the like.

For ease of illustration, an exemplary implementation for determining opinion leader information with regard to medical practitioners for use by pharmaceutical representatives is discussed in detail below. However, the exemplary system(s) and method(s) discussed herein can be adapted for other purposes without departing from the spirit or the scope of the present invention. Indeed, the present invention could be implemented to determine opinion leaders in the fields of politics, law, engineering, business, fashion, academics, as well as any other field wherein a subset of individuals or entities have an identifiable and appreciable impact on their respective field.

The term “opinion leader survey,” as used herein, refers to a survey having questions or input fields that may be used by a survey participant to identify one or more opinion leaders from the perspective of the survey participant. The opinion leader survey also may include questions or input fields used to obtain information about the identified opinion leaders and/or to obtain additional information about the survey participant. The term “medical practitioner,” as used herein, refers to an individual who is involved in the prescription, distribution, purchase, or use of drugs or other pharmaceuticals. Examples of medical practitioners can include, but are not limited to, physicians, psychiatrists, psychologists, pharmacists, nurses, physician assistants, hospital administrators, medical experts, and the like. The term “pharmaceutical representative,” as used herein, refers to an individual who is involved in the marketing and/or sales of drugs or other pharmaceuticals produced by a pharmaceutical manufacturer.

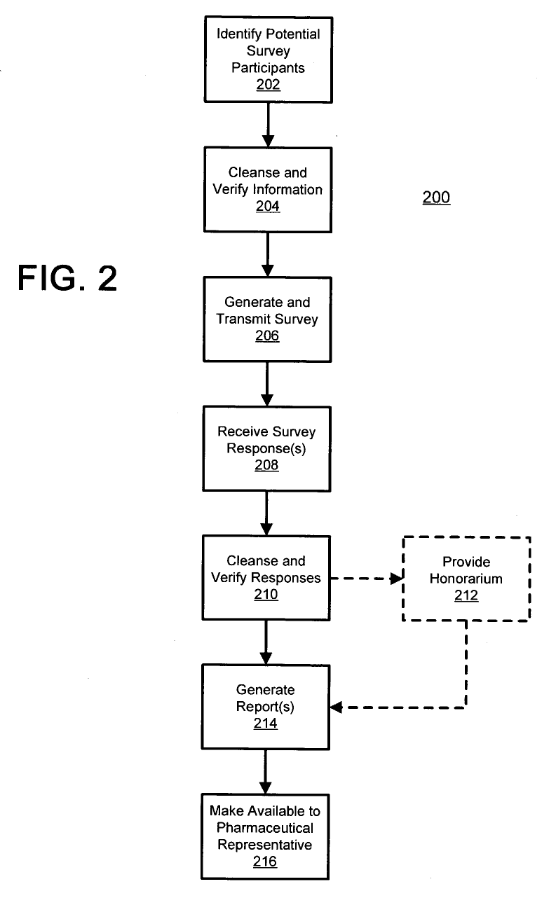

Referring now to FIGS. 1 and 2, an exemplary automated system and method for opinion leader surveying is illustrated in accordance with at least one embodiment of the present invention. The exemplary method 200 initiates at step 202, wherein a plurality of medical practitioners 102-108 are selected to receive an opinion leader survey used to identify opinion leaders within a particular medical field. The medical practitioners 102-108 may be selected in any of a variety of ways. In one embodiment, the medical practitioners 102-108 are selected from one or more lists obtained from industry publications, continuing medical education (CME) conferences, medical journal listings, hospital listings, business directory listings, medical directory listings, physician directory listings, and the like. Alternatively, in another embodiment, a list of the practitioners 102-108 to be surveyed is provided by one or more pharmaceutical manufacturers. To illustrate, a pharmaceutical manufacturer for whom a survey is being performed may supply a list of practitioners in the specified medical field who have previous contacts with the pharmaceutical manufacturer.

At step 204, the survey participant information is cleansed and verified. The information can be “cleansed” by identifying multiple entries for the same survey participant (e.g., survey participants who appear in the participant list two or more times due to a slight misspelling of a name or a change of address). Likewise, survey participant information can be compared with other sources, such as published United States Postal Service address information, to confirm the accuracy of the survey participant information.

Additionally, the list of potential survey participants can be compared to a variety of other lists to identify potential survey participants to be removed or added. For example, the potential survey participant list could be compared to a list of previous survey participants for a survey in the same or similar medical field. Those potential survey participants who have recently participated in another survey then could be removed from the potential survey list.

After cleansing, the personal information for the potential survey participants is verified. The personal information includes various contact information regarding the potential survey participant, such as the participant's full name, work address, home address, work telephone, home telephone, e-mail address, the institute where the participant works, the participant's medical specialty, and the like. The verification of this data can be accomplished by manual efforts, by an automated process, or a combination thereof. To illustrate, one or more staff members could review the personal information of the potential survey participants to identify any information that needs verification (e.g., a seemingly misspelled name) or is missing (e.g., a work telephone number). The staff members then could contact the potential survey participant by phone, facsimile, mail, and/or e-mail to verify the questionable information and/or to obtain the necessary information. Alternatively, some or all of the verification process could be automated by the key opinion leader (KOL) system 120. To illustrate, the KOL system 120 could utilize an Internet-based business directory to confirm address and phone information, utilize an e-mail server to send a test e-mail to confirm a correct e-mail address, and the like. The cleansed/verified survey participant information then can be stored to a survey database 128 for subsequent use.

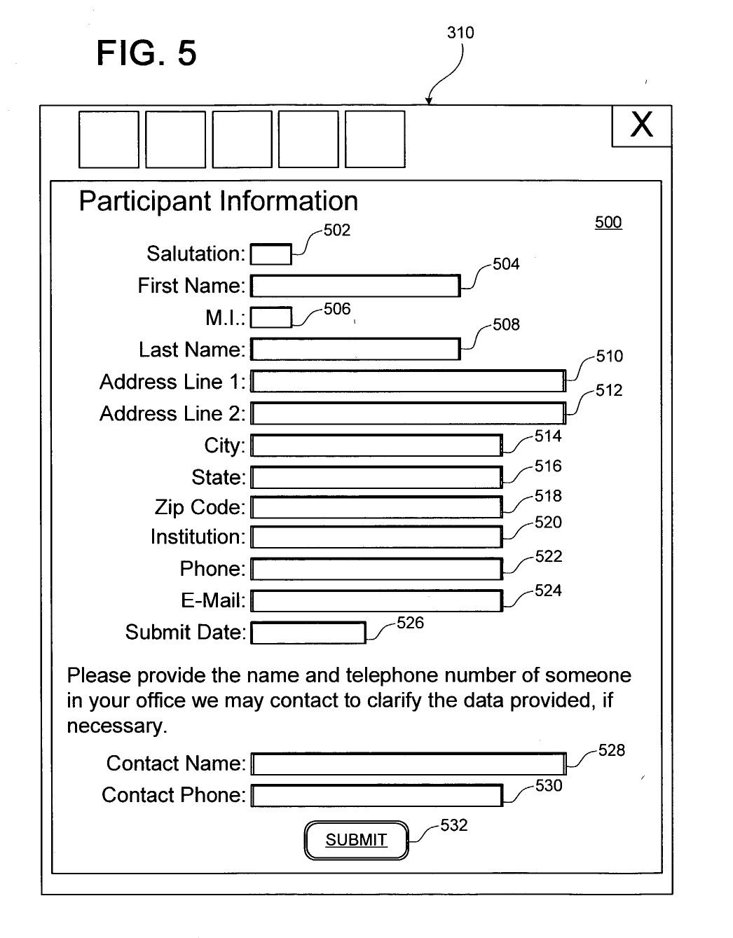

After cleansing/verification of the participant information, an opinion leader survey 110 is generated and sent to the identified survey participants 102-108 at step 206. The opinion leader survey 110, in at least one embodiment, is formatted to elicit responses from the survey participants 102-108 that identify medical practitioners whom the survey participants 102-108 confer with or whom the survey participants 102-108 believe are influential within their medical field. Accordingly, the opinion leader survey 110, in at least one embodiment, directs the survey respondent to identify medical practitioners who the survey respondent believes is an opinion leader on a local, regional, or national scale. An exemplary web page-based opinion leader survey is illustrated in greater detail below with reference with FIGS. 5-8.

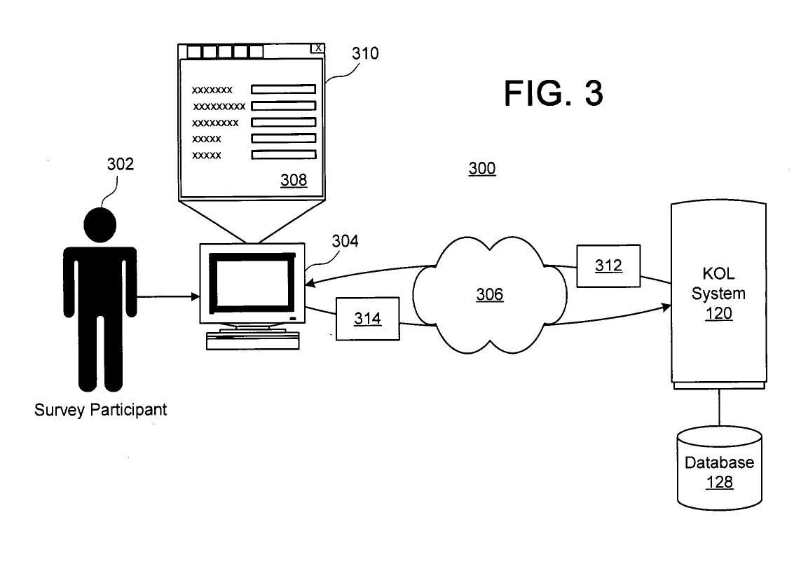

The opinion leader survey 110 can be provided to the survey participants 102-108 in any of a variety of ways, such as by mail, by telephone, by facsimile, and the like. In a preferred embodiment, the KOL system 120 is adapted to provide the opinion leader survey 110 in an electronic form, such as by e-mail or using a website whereby survey participants 102-108 can access the survey 110 and provide their input “online” (i.e., through the website). The implementation of a website to obtain survey results is illustrated in greater detail with reference to FIG. 3.

At step 208, the survey responses 112-118 from some or all of the survey participants 102-108 are received and the information contained therein is provided to the KOL system 120. Where a survey response is received via fax, mail, or telephone, a data entry specialist typically converts the survey response information into electronic form for storage in the survey database 128. Should a survey response arrive via e-mail or via a website provided by the KOL system 120, the KOL system 120 can be adapted to automatically parse the desired survey response information from the e-mail or the website input and store the parsed information in the survey database 128.

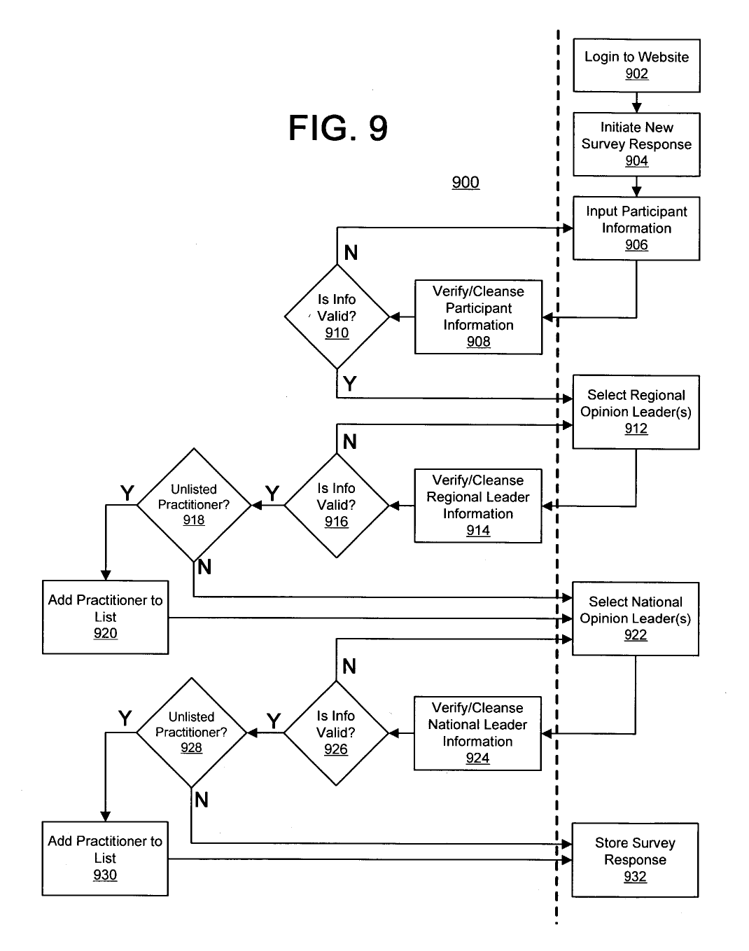

When a survey response is received and input to the KOL system 120, information represented by the survey response can be cleansed and/or verified at step 210 in a manner similar to step 204. To illustrate, the KOL system 120 could be adapted to monitor the incoming survey responses for fields that are missing information, commonly misspelled information, and the like. In many cases, an honorarium (e.g., money, a gift certificate, and the like) is offered to potential survey participants to induce them to complete and return the opinion leader survey 110. Some individuals occasionally are tempted to submit multiple survey responses in the hopes of receiving multiple honoraria and some individuals who were not invited to complete the survey 110 may provide a survey response in the hope of receiving an honorarium. Accordingly, the KOL system 120 also can be adapted to compare the information from a received survey response with the information from the survey participant list to identify survey responses that appear to be from an individual that is not one of the survey participants or to identify multiple survey responses from the same survey participant. In the event that the KOL system 120 detects missing information, information needing verification, multiple survey responses for the same participant, or survey responses from an uninvited participant, the KOL system 120 can notify an administrator by, for example, sending an e-mail to the administrator, recording an entry in a log file, and the like. Alternatively, the KOL system 120 can be adapted to manage the survey response information directly, such as by deleting redundant survey responses, deleting uninvited survey responses, and the like. After the information from a survey response is verified and/or cleansed, the survey response is stored in the survey database 128. An exemplary method for obtaining survey responses via a website is illustrated in greater detail below with reference to FIG. 9. As mentioned previously, an honorarium may be offered in exchange for a practitioner's participation in the survey. In this case, the KOL 120 can initiate the provision of the honorarium to the participant at step 212 after verifying that all required information from the participant has been obtained and deemed reliable.

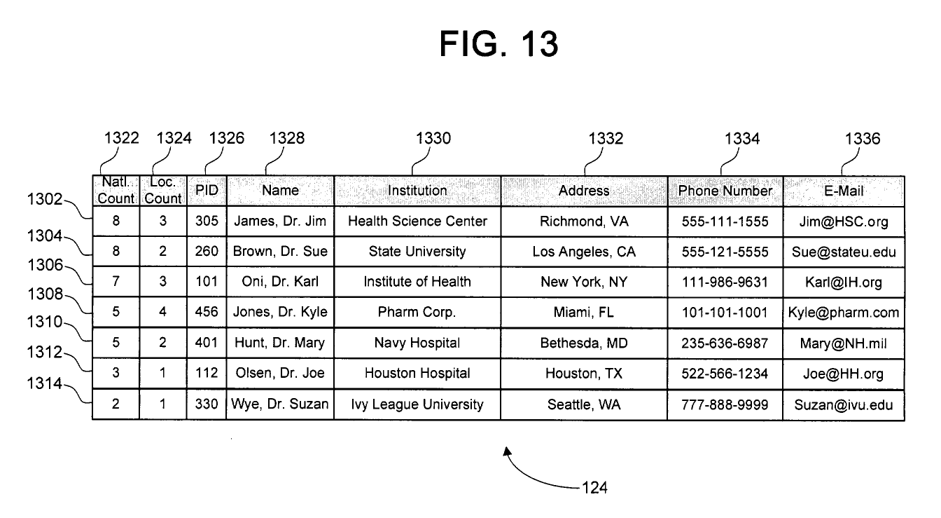

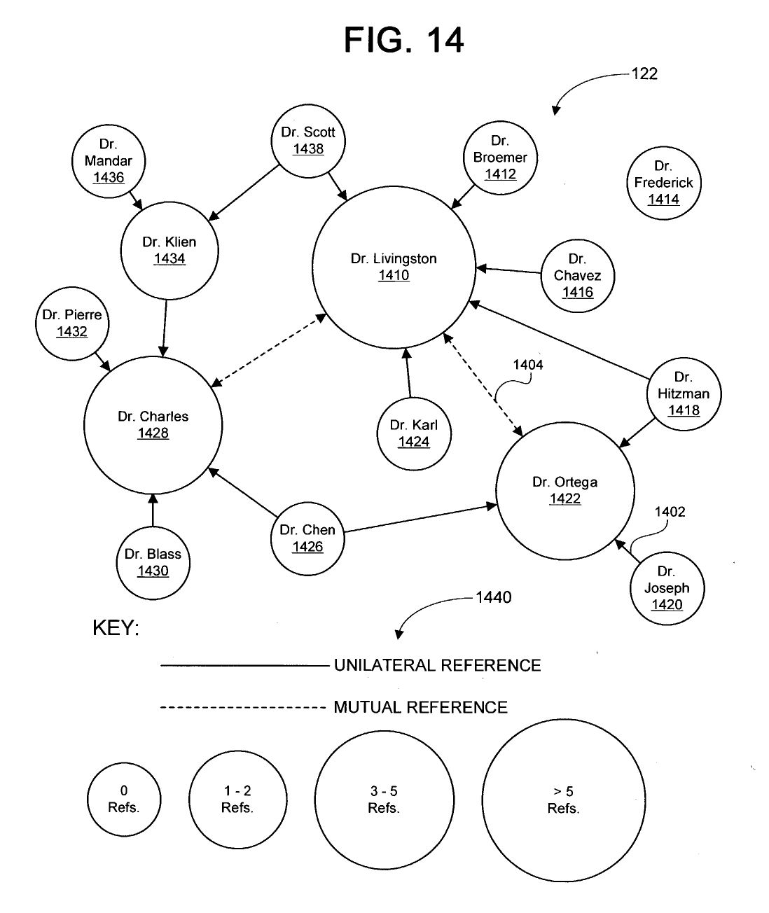

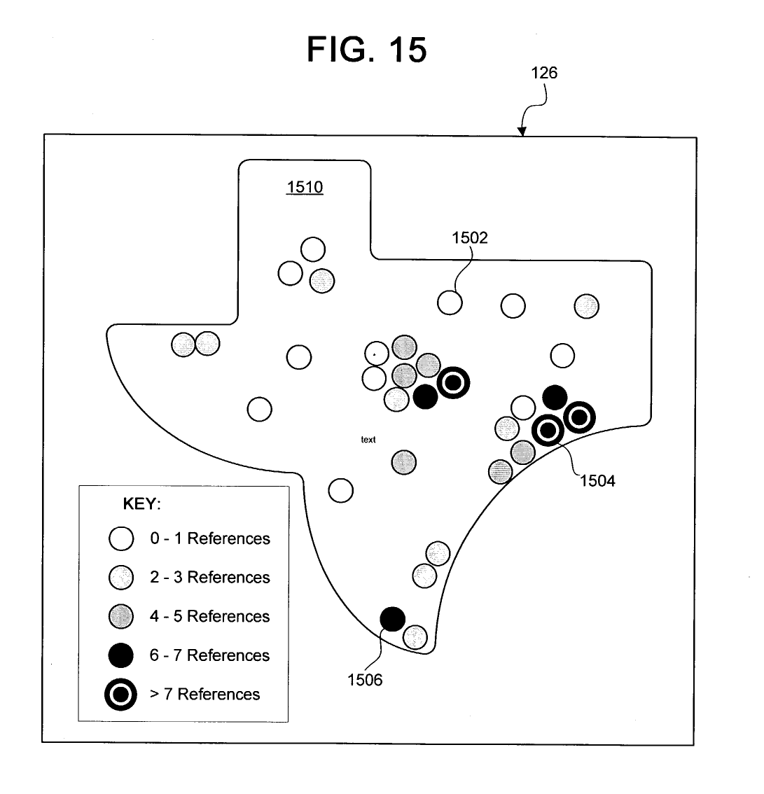

After a requisite number of survey responses are received and processed by the KOL system 120, the system 120 generates one or more reports for use by one or more pharmaceutical representatives 130 (FIG. 1B) at step 214. The reports can include any of a variety of techniques for presenting information. For example, in at least one embodiment, the KOL system 120 is adapted to generate one or more tables 124, where the tables 124 include a table or spreadsheet that lists the survey response information. For example, the table 124 could include a list of those medical practitioners identified by the survey participants, the number of times identified, the affiliated institution, work contact information, and the like. An exemplary table 124 is illustrated in greater detail with reference to FIG. 13. In another embodiment, the generated report(s) include at least one relationship graph 122, whereby the relationships between opinion leaders an/or survey participants are displayed in a graphical form. An exemplary relationship graph 122 is illustrated in greater detail with reference to FIG. 14. In yet another embodiment, the generated report(s) include at least one opinion leader map 126, whereby the geographical location of the survey participants/opinion leaders are overlaid on a geographical map of a particular locality or region. An exemplary opinion leader map 126 is illustrated in greater detail with reference to FIG. 15.

The some or all of the report(s) generated from survey responses preferably are presented in a hierarchical format, whereby a report recipient can navigate through the report to obtain different layers of information. For example, the table 124 preferably is implemented as one or more web pages. In this case, the web pages can be adapted to allow the report recipient to access additional information associated with an entry of the table 124 by, for example, selecting the entry within the web page using an input device (e.g., a mouse or a keyboard). Although a number of report styles have been discussed, those skilled in the art can implement alternate report styles using the guidelines provided herein without departing from the spirit or the scope of the present invention. Such alternate report styles can include, for example, bar charts, pie charts, line charts, and the like.

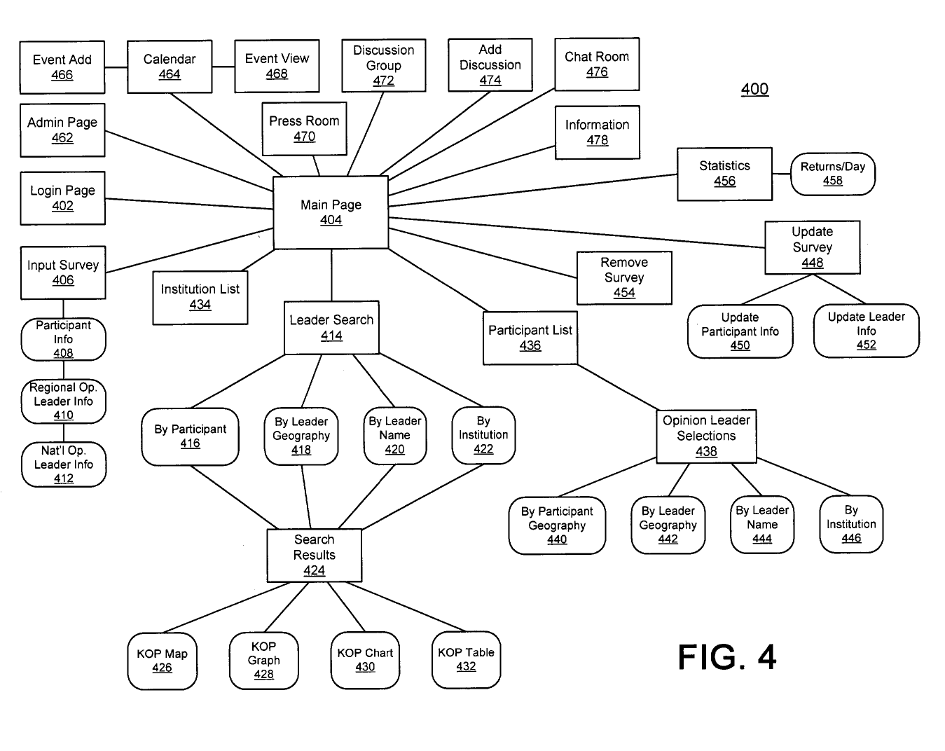

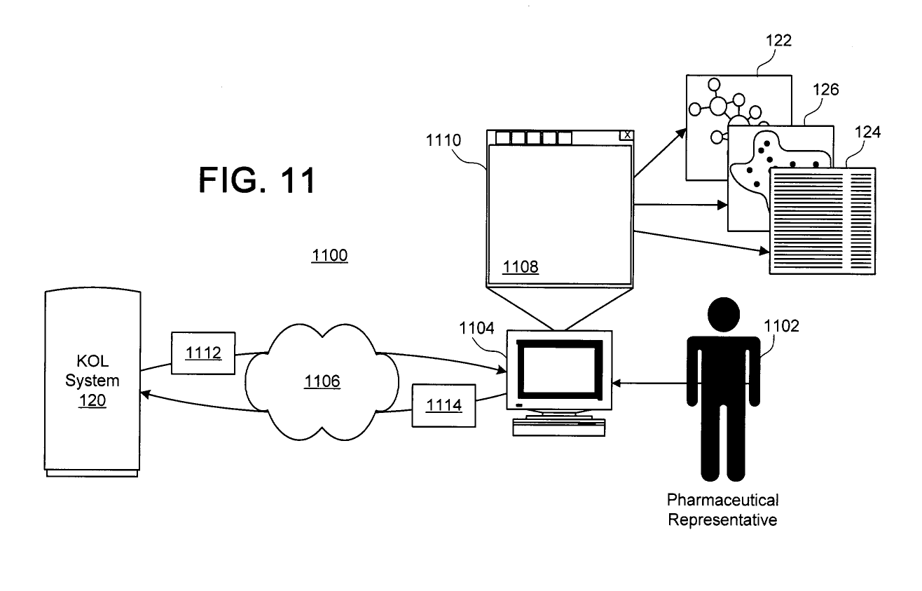

At step 216, the one or more generated report(s) are made available to the pharmaceutical representative 130 (one embodiment of a report recipient). The report(s) can be provided as hardcopies, as electronically transmitted data file(s), or as data files provided via a storage medium to the pharmaceutical representative 130 for use with one or more software applications. Alternatively, in one embodiment the KOL system 120 is adapted to provide a website that may be used by the pharmaceutical representative 130 to obtain/view the generated report(s) and/or access the raw data used to generate the report(s). An exemplary implementation of a website to provide access to the report(s) and/or the survey responses is illustrated with reference to FIGS. 4 and 11.

It will be appreciated that considerable effort and expense on the part of the pharmaceutical representative 130 can be saved if the pharmaceutical representative 130 can properly identify those key opinion leaders 132, 134 who hold considerable influence over other medical practitioners 136-156. Rather than having to approach each of the medical practitioners 132-156, pharmaceutical representatives 130 can focus their marketing efforts on the key opinion leaders 132, 134. The key opinion leaders 132, 134, if convinced by the marketing effort, then can compel other practitioners 136-156 to consider the products championed by the key opinion leaders 132, 134. As discussed in greater detail herein, the reports 122-126 can assist the pharmaceutical representative 130 in effectively identifying key opinion leaders by presenting survey reports in formats that allow the pharmaceutical representative 130 to more clearly understand the relationships between opinion leaders and other medical practitioners.

Referring now to FIG. 3, an exemplary system 300 for receiving survey responses from one or more survey participants via a website is illustrated in accordance with at least one embodiment of the present invention. The exemplary system 300 includes one or more network devices 304 connected to the KOL system 120 via a network 306. The network device 304 can include any of a variety of processing devices capable of displaying information and receiving input from a survey participant 302 and further capable of sending a representation of the input to the KOL system 120 via the network 306. Examples of the network device 304 can include, but are not limited to, a personal computer, a notebook computer, a networked personal digital assistant (PDA), a cellular phone, a two-way pager, and the like. The network 306 can include a local area network (LAN), a wide area network (WAN), a metro area network (MAN), the Internet, or a combination thereof. A variety of network mediums can be implemented in network 306, such as wire-based networks, fiber-optic networks, wireless networks, and the like.

In at least one embodiment, the KOL system 120 is adapted to provide a website (website 400, FIG. 4) for use by the survey participant 302 to input a survey response, modify a survey response, and/or delete a survey response via the network device 304. The term “website,” as used herein, refers to a grouping of one or more web pages 308 navigable by a web browser 310 of the network device 304. The term “web page,” as used herein, refers to a graphical user interface (GUI) adapted for display on the web browser 310, and further being adapted to receive input from the survey respondent 302 and to transmit the input information to the KOL system 120 via the web browser 310, network device 304, and network 306. The web pages 308 can include web pages representing an “online” opinion leader survey, web pages for system administration, web pages for displaying information, and the like. An exemplary website provided by the KOL system 120 is discussed in greater detail with reference to FIG. 4.

Representations of the web page(s) 308 are transmitted to the network device 304 for display by the web browser 310 in the form of one or more data files 312 (or data streams). The data file 312 can include any of a variety of file formats including, but not limited to, a Hypertext Markup Language (HTML) file, an Extensible Markup Language (XML) file, a Java Applet file, or other set of data sent using one or more protocols, such as Simple Object Access Protocol (SOAP), Open Data Base Connectivity (ODBC), Java Data Base Connectivity (JDBC), Active Server Pages (ASP) and ASP.NET, ActiveX Data Object (ADO), Web Services, and the like. The web browser 310 can include a software application adapted to display a graphical representation of web page 308. Exemplary web browsers 310 include the Netscape® Communicator web browser available from Netscape Communication Corp. of Mountain View Calif. and the Internet Explorer web browser available from Microsoft Corp. of Redmond, Wash.

The KOL system 120, in one embodiment, includes a data server adapted to generate and/or transmit one or more files 312 to the web browser 310 over the network 306. The data server/KOL system 120 can be further adapted to receive information provided by the survey participant (survey response information 314) from the web browser 310 via the network 306. Any of a variety of data transmission techniques between the KOL system 120 and the web browser 310 can be utilized and the KOL system 120 may implement one or more network protocols, such as the Hypertext Transfer Protocol (HTTP), Transfer Control Protocol/Internet Protocol (TCP/IP), User Datagram Protocol (UDP), and the like. Exemplary data servers that may be implemented by the KOL system 120 include, but are not limited to: Internet Information Server (IIS) available from Microsoft Corp. of Redmond, Wash.; Sun ONE web server available from Sun Microsystems, Inc. of Santa Clara, Calif.; and Apache HTTP Server available from The Apache Software Foundation of Forest Hill, Md.

The system 300 may be better understood by considering the following example. After identifying the survey participant as a potential survey participant (steps 202, 204, FIG. 2), the KOL system 102 can be adapted to generate a web page 308 representing an “online” opinion leader survey having input fields for receiving input from survey participants (step 206, FIG. 2). An example of an “online” opinion leader survey is illustrated with reference to FIGS. 5-8. The file(s) 312 representing the “online” opinion leader survey web page(s) can be stored in the database 128 for subsequent retrieval.

The survey respondent 302 then is invited to participate in the “online” opinion leader survey. The invitation can be transmitted to the survey participant 302 by, for example, e-mail, facsimile, mail, a telephone call, publication in a journal, conference outline or other publication, and the like. The invitation typically includes information for accessing the website, such as the location of the website (e.g., the Uniform Resource Locator (URL) address of the website), a user identification and password used to gain access to the website, and the like.

Using the information supplied with the invitation, the survey participant 302 can direct the web browser 310 to request the file(s) 312 associated with the “online” opinion leader survey. Upon receipt of this request, the KOL system 120 can extract the file(s) 312 from the database 128 and transmit them to the web browser 310 via the network 306. Upon receipt of the file(s) 312, the web browser 310 displays the web page(s) represented by the file(s) 312. The survey participant 302 then may input the information into the desired input fields of the web page(s) and transmit the input information to the KOL system 120 as survey response information 314 (step 208, FIG. 2). The KOL system 120 then cleanses and/or verifies the survey response information 314 (step 210, FIG. 2), and stores the survey response information 314 to the survey database 128. The KOL system 120 then may use the survey response information 314 stored in the database 128 to generate one or more reports (step 214, FIG. 2). The KOL system 120 further can be adapted to provide these report(s) to pharmaceutical representatives via the website (step 216, FIG. 2), as described in greater detail below with reference to FIG. 11.

Referring now to FIG. 4, an exemplary map of a website 400 provided by the KOL system 120 is illustrated in accordance with at least one embodiment of the present invention. As noted above, the website 400 can include a plurality of web pages used by various individuals to participate in an opinion leader survey, generate reports, locate survey participants and/or opinion leaders, perform various administrative tasks, and the like. Those website elements of FIG. 4 having square edges (e.g., main web page 404) represent web pages for display, whereas those website elements having round edges (e.g., website element 458) represent information obtained from the survey participant, variations of techniques for displaying information, and information generated based on the use of the website, and may include one or more web pages used to display any pertinent information or to obtain information from the survey participant.

To access the website, the individual accessing the website (“visitor” herein) typically is presented with a login web page 402 wherein the visitor provides a user ID and/or password for verification. Upon successful verification, the visitor is directed to a main web page 404, wherein the main web page 404 may display information pertinent to the visitor. From the main web page 404, the visitor may access an input survey web page 406, an institution list web page 434, a leader search web page 414, a participant list web page 436, an update survey web page 448, a remove survey web page 454, and a statistics web page 456, among others.

The input survey web page 406 typically includes one or more web pages adapted to receive opinion leader survey information from one or more survey participants. The input survey web page 406 can be implemented to obtain information regarding the survey participant information (website element 408), obtain information identifying those practitioners thought to be local opinion leaders (website element 410) and/or national opinion leaders (website element 412) by the survey participant, and the like. Exemplary web pages for receiving survey responses are illustrated with reference to FIGS. 5-8.

A survey participant can use the update survey web page 448 to update participant information (website element 450) and/or to modify the list of regional and/or national opinion leaders identified by the participant (website element 452). An administrator or participant can use the remove survey web page 454 to remove one or more survey responses for any of a variety of reasons. The statistics web page 456 can be used by an administrator to view statistics with regard to the receipt of survey responses, such as a periodically updated list of survey responses received (website element 458), the number of survey responses that have not yet been received at the time that the statistics web page 456 is accessed, the number of returned survey responses received per day, and the like. This statistical information can be utilized to determine the efficacy of the survey, identify processes or components of the surveying process that need improvement, and the like. The institution list web page 434 can be used by a visitor to view a list of the institutions affiliated with the survey participants and/or opinion leaders.

Certain visitors (e.g., report recipients) can use the participant list web page 436 to obtain a list of survey participants. From this list, a visitor can access an opinion leader selection web page 438 that displays the regional and/or national opinion leaders identified by a survey participant selected from the participant list web page 436. Those regional and/or national opinion leaders displayed can be limited to a particular geography of the participant (website element 440), to a particular geography of the identified opinion leaders (website element 442), to a particular opinion leader name (website element 444), to a particular affiliated institution (website element 446), and the like.

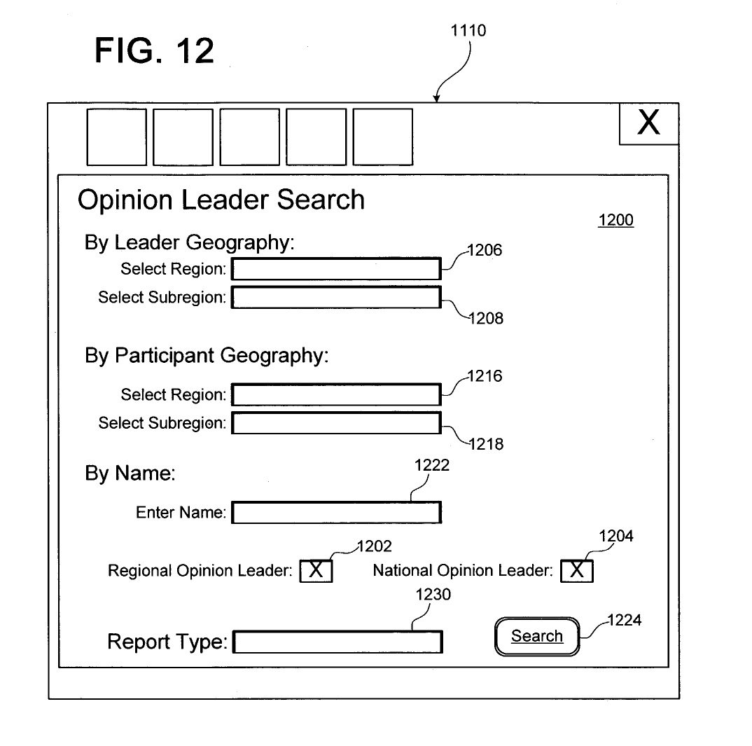

The website 400 also may be implemented to allow certain visitors (e.g., pharmaceutical representatives) to search for opinion leaders, generate reports, and the like. The leader search web page 414 can be utilized by a visitor to search for opinion leaders, where the displayed opinion leaders can be limited by survey participant (website element 416), by geography of the opinion leaders (website element 418), by name (website element 420), and by affiliated institution (website element 422). In one embodiment, the results of the search performed using the leader search web page 414 can be provided as a hardcopy or provided as a file for later manipulation by the visitor. In another embodiment, the search results are displayed at a search results web page 424. The results can be displayed at the search results web page 424 as a map (website element 426), a relationship graph (website element 428), a chart (website element 430), a table (website element 432), as well as other formats as appropriate. The visitor then can print the displayed report(s); export the reports to a file for subsequent manipulation; and the like. Exemplary implementations of the leader search web page 414 and the displayed reports are illustrated with reference to FIGS. 12-15.

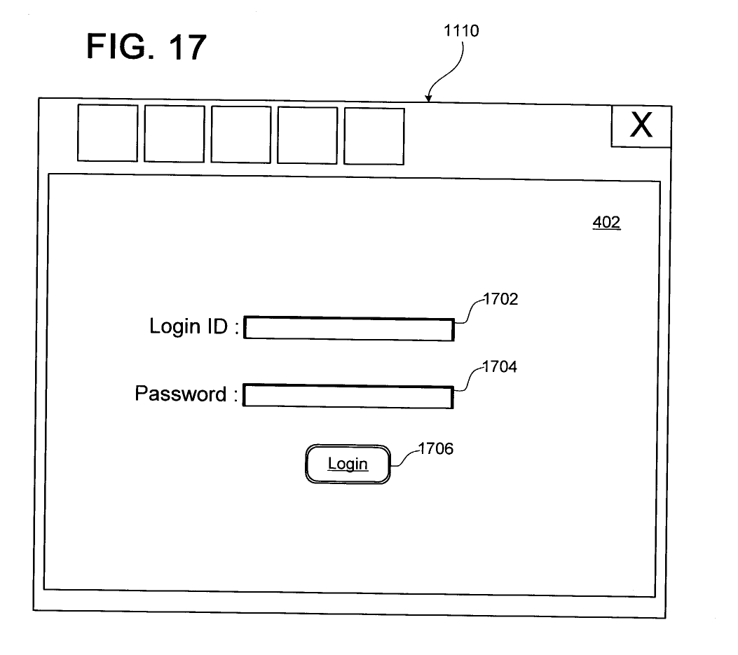

In at least one embodiment, the website 400 further includes a number of web pages 462-478 that serve as a “community portal” for medical practitioners, survey respondents, report recipients, and other interested parties. The community portal can include an administration web page 462 whereby the community portal can be administered, a calendar web page 464 for displaying a calendar of events, the events being added by add event web page 466 and viewed using the view event web page 468. The community portal can further include a press room 470 and information web page 478 for displaying press releases and other information related to a certain pharmaceutical manufacturer, a certain medical topic, a certain drug or therapy, and the like. A discussion group web page 472 can be implemented to allow website visitors to communicate on certain issues using a discussion-group format, where a visitor can post a discussion topic or reply to a posted discussion topic using an add discussion web page 474. Similarly, the community portal can include a chat room web page 476 whereby visitors can communicate via one or more chat rooms. The web pages of the community portal are discussed in greater detail with reference to FIGS. 17-27.

Referring now to FIGS. 5-8, exemplary web pages 500-800 representing an “online” survey for obtaining opinion leader information from a survey participant are illustrated in accordance with at least one embodiment of the present invention. As noted above, one or more files representing the web pages 500-800 can be transmitted from the KOL system 120 (FIG. 3) to a web browser 310 for display to a survey participant. The survey participant then may provide survey response information by providing input or otherwise manipulating one or more input fields of the web pages 500-800. The term “input field,” as used herein, refers to an element of a web page that a visitor can manipulate to submit information. Examples of input fields include, but are not limited to, text boxes for receiving input text, drop-down boxes to select an input from a predetermined list, a radio button or check box to indicate the selection of a presented option, and the like.

Note that the web pages 500-800 represent an exemplary implementation of an “online” opinion leader survey and are discussed for explanatory purposes. Those skilled in the art can develop, using the guidelines provided herein, an online opinion leader survey having a different format without departing from the spirit or the scope of the present invention. For example, an “online” key opinion survey having fewer or more input fields could be utilized, as could a single web page implementing some or all of the content of the web pages 500-800.

FIG. 5 illustrates an exemplary participant information web page 500 for obtaining information regarding the survey participant. In the illustrated embodiment, the web page 500 includes a salutation input field 502 to indicate the salutation (e.g., Mr., Ms., Mrs., Dr., etc.) preferred by the survey participant and name input fields 504-508 to receive the full name of the survey participant. Address input fields 510, 512, a city input field 514, a state input field 516 and a zip code input field 518 can be used to identify the work or home address of the survey participant. A phone input field 522 and e-mail input field 524 can identify the phone number and e-mail address, respectively, of the survey participant. The survey participant can use an institution input field 520 to identify the institution (e.g., medical office, hospital, research center, university, etc.) affiliated with the survey participant. The web page 500 further can include a submit date input field 526 whereby the survey participant can indicate the date of submission of the survey response.

As noted above, it often is desirable to verify information provided by a survey participant. Accordingly, the web page 500 can include a contact name input field 528 and contact phone input field 530 of an associate of the survey participant. For example, if the survey participant included a physician at a medical office, the participant could provide the name and number of the office receptionist. In the event that the participant's survey response information is incomplete or seemingly incorrect, an administrator could contact the office receptionist to verify the information or obtain additional information without further inconveniencing the survey participant.

After supplying information to some or all of the input fields 502-530, the survey participant can submit the information by selecting, for example, a submit object 532 of the web page 500. The information entered into the input fields 502-530 is assembled into the survey response file(s) 314 (FIG. 3) and transmitted by the web browser 310 to the KOL system 120.

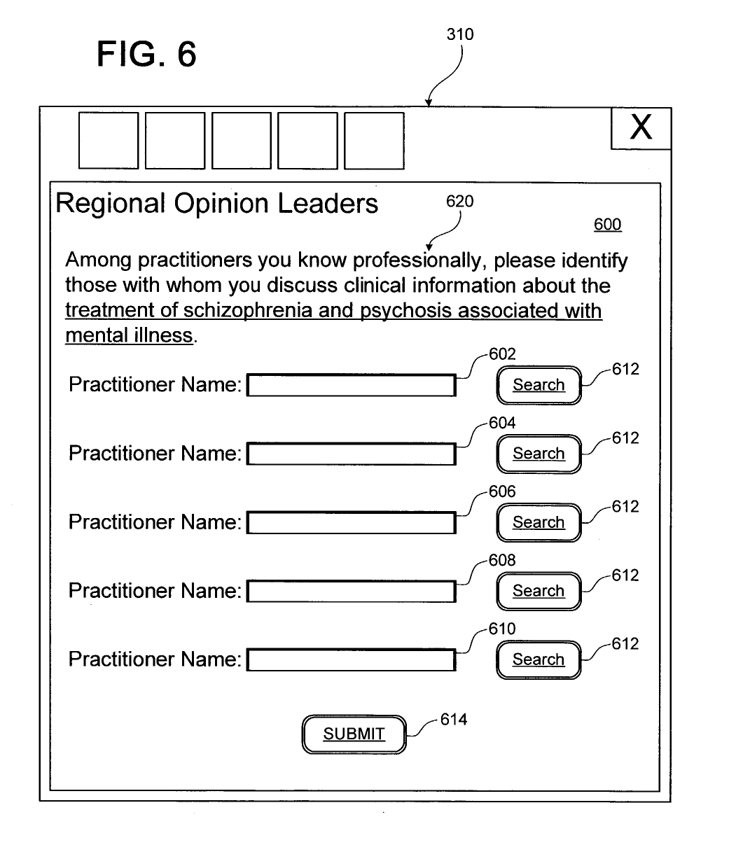

FIG. 6 represents an exemplary web page 600 for obtaining regional opinion leader information from a survey participant. The web page 600 preferably is displayed after the survey participant has provided participant information via, for example, web page 500 of FIG. 5. In the illustrated embodiment, the web page 600 includes an instruction text field 620 used to instruct or inform the survey participant with regard to the regional local opinion leader survey portion represented by web page 600. To illustrate, the instruction text field 620 could direct the survey participant to identify one or more medical practitioners with whom the survey participant discussed clinical information about a certain topic, such as the treatment of schizophrenia and psychosis.

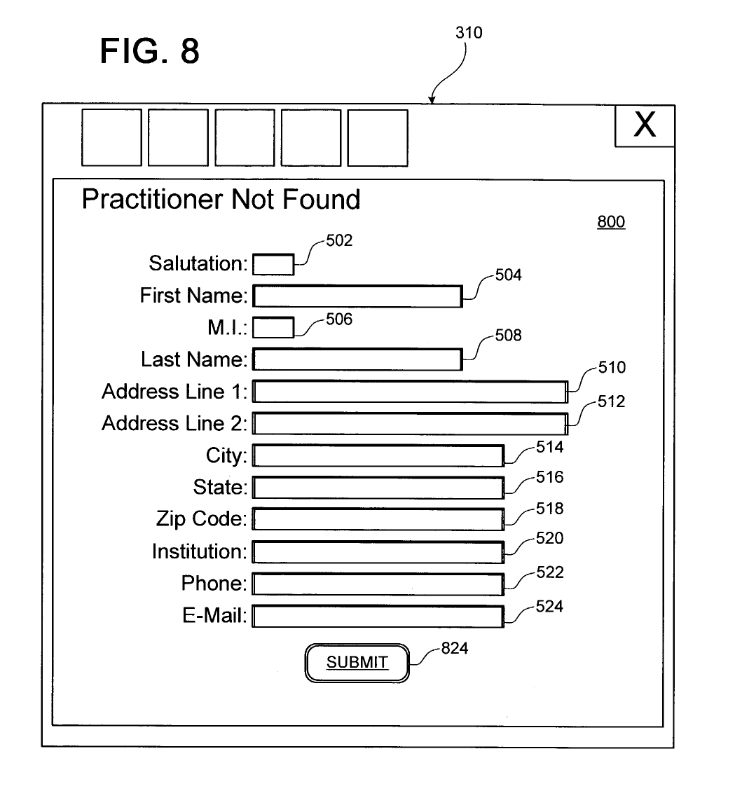

The web page 600 further includes one or more practitioner input fields 602-610 that are used by the survey participant to identify those practitioners who the survey participant believes are regional opinion leaders for the identified topic. In one embodiment, the survey participant can search a predetermined list of practitioners by providing at least part of the identified practitioner's name (or other information) into one of the practitioner input fields 602-610 and then selecting, for example, a search object 612 to initiate the search. The search term (i.e., the partial practitioner information) is submitted by the web browser 310 to the KOL system 120 (FIG. 3). The KOL system 120 then can search the database 128 (FIG. 3) for practitioners whose information matches or is similar to the supplied search terms. The KOL system 120 then can provide a list or table of the found practitioners the web browser 310 for display by the web page 600. If the intended practitioner is included in the displayed list, the survey participant can select the intended practitioner from the list for inclusion as an identified regional opinion leader. If the intended practitioner is not listed, the survey participant can provide information regarding the intended practitioner using, for example, the web page 800 (FIG. 8) discussed below.

After the requisite number of practitioners have been selected as regional opinion leaders, survey participants can submit their selections using, for example, the submit object 614, whereupon the selected participants are assembled into one or more survey response files 314 by the web browser 310 and transmitted to the KOL system 120 for inclusion into the survey database 128.

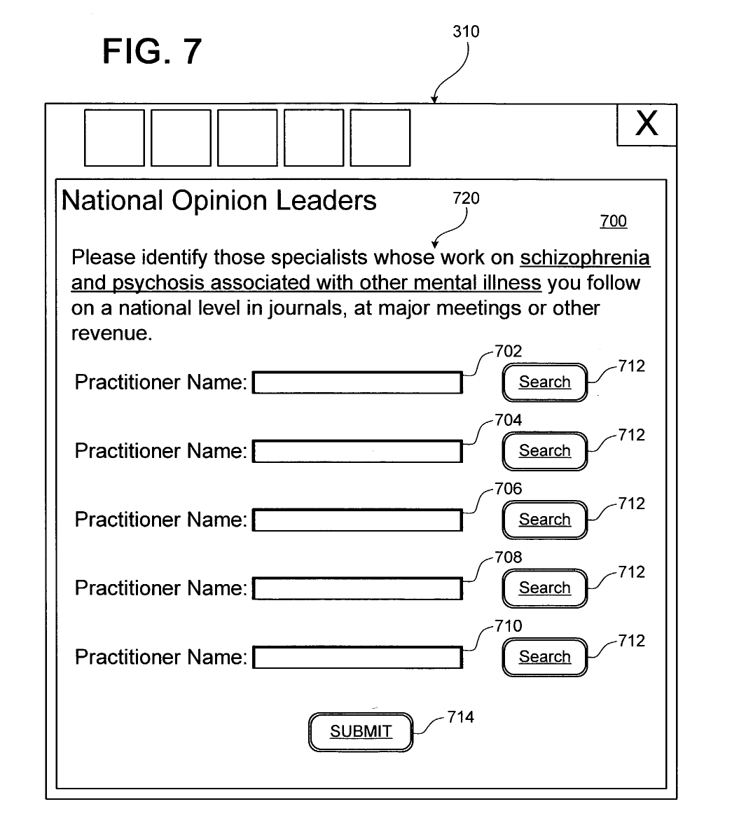

FIG. 7 illustrates an exemplary web page 700 for obtaining national opinion leader information from a survey participant. As with the web page 600 (FIG. 6) for regional opinion leader information, the web page 700 can include an instruction text field 720 to instruct or inform the survey participant as to the purpose of the national opinion leader survey, as well as including one or more practitioner input fields 702-710 whereby the survey participant can identify practitioners believed to be national opinion leaders for the identified topic of the survey. Additionally, the survey participants can supply partial information regarding a practitioner and, using the search object 712, direct the KOL system 120 to search for participants having information that matches or is similar to the submitted information as discussed above. After the requisite number of practitioners have been selected as national opinion leaders, survey participants can submit their selections using, for example, the submit object 714, whereupon the selected participants are assembled into one or more survey response files 314 by the web browser 310 and transmitted to the KOL system 120 for inclusion into the survey database 128.

FIG. 8 illustrates an exemplary web page 800 for obtaining information regarding an unlisted practitioner identified by a survey participant is illustrated. As noted above, the web pages 600, 700 (FIGS. 6, 7) can be adapted to receive partial information regarding a participant and to submit this partial information to the KOL system 120 (FIG. 3) for a search of a practitioner list in the database 128 (FIG. 3). In the event that the KOL system 120 cannot identify a potential practitioner from the database 128, or in the event that none of identified potential practitioner(s) represents the intended practitioner, the web page 800 can be displayed to obtain information regarding an unlisted practitioner. The information for the unlisted practitioner then can be added to the database 128 and the practitioner added to the practitioner list.

In the illustrated embodiment, the web page 800 includes the salutation input field 502, the name input fields 504-508, the address input fields 510, 512, the city input field 514, the state input field 516, the zip code input field 518, the institution input field 520, the phone input field 522 and the e-mail input field 524, all of which are discussed above with reference to web page 500 (FIG. 5).

After supplying some or all of the practitioner information, the survey participant can submit the information by selecting, for example, the submit object 824. The web browser 310 then assembles the information input to the input fields 502-524 into a survey response file 314 (FIG. 3) and transmitted to the KOL system 120 for inclusion in the database 128.

Referring now to FIG. 9, an exemplary method 900 for receiving and processing survey responses input via the web pages 500-800 (FIGS. 5-8, respectively) is illustrated in accordance with at least one embodiment of the present invention. The exemplary method 900 initiates at step 902, whereby a survey participant accesses the main web page 404 (FIG. 4) of the website via the login web page 402 (FIG. 4). From the main web page 404, the survey participant navigates to the input survey web page 406 (FIG. 4) and initiates a new survey response at step 904. At step 906, the survey participant supplies participant information to KOL system 120 (FIG. 3) via the web page 500 (FIG. 5), as discussed above. Upon receipt of this information, the KOL system 120 can be adapted to verify and/or cleanse the participant information (step 908). For example, the KOL system 120 could analyze the disclosed participant information to determine if any required information has been omitted. At step 910, the KOL system 120 determines if the supplied information is valid. In the event that the supplied participant information is not valid (i.e., required information is missing, the participant information substantially matches information previously submitted, and the like), the KOL system 120 redirects the survey practitioner to the web page 500 to supply the required data. Steps 906-910 can be repeated until the KOL system 120 deem the supplied information valid.

The method 900 continues at step 912, whereby the survey participant is directed to the web page 600 used to obtain regional opinion leader from the survey participant. At step 914, the local opinion leader information supplied by survey participant is verified and/or cleansed and its validity is considered at step 916. If the information is deemed invalid, the steps 912-916 can be repeated until the supplied regional opinion leader information is deemed valid. If the KOL system 120 determines that an identified regional opinion leader is not represented in the survey database 128 (step 918), the survey participant can provide practitioner information about the unlisted regional opinion leader using the web page 800 (FIG. 8) at step 920.

The method 900 continues at step 922, whereby national opinion leader information is supplied by the survey participant via, for example, the web page 700 (FIG. 7). As with step 914, the national opinion leader information is verified and/or cleansed at step 924 and its validity is determined at step 926. If the submitted national opinion leader information is deemed invalid in whole or part, the steps 922-926 can be repeated until determined to be valid. At step 928, the practitioner information for any unlisted practitioners identified at step 928 can be added to the survey database 128 using the web page 800 at step 930. At step 932, the practitioner information, regional opinion leader information, and/or the national opinion leader information (collectively the survey response) obtained from the survey participant are stored to the survey database 128 (FIG. 3).

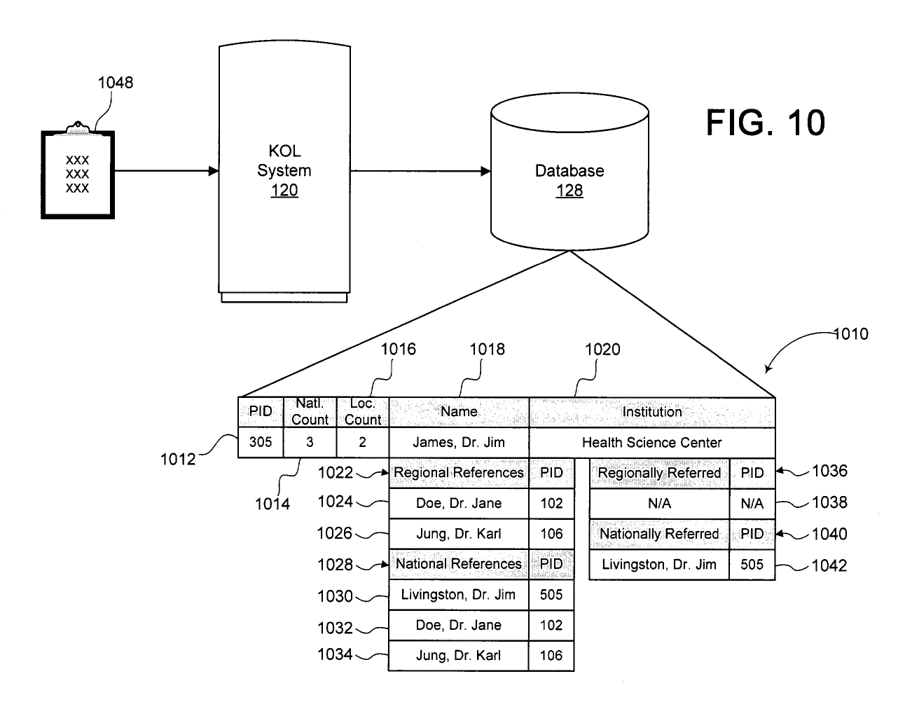

Referring now to FIG. 10, an exemplary technique for storing survey information in the survey database 128 is illustrated in accordance with at least one embodiment of the present invention. Recall that, in one embodiment, the survey database 128 is adapted to store survey information that can include lists or tables of survey participants, both actual and potential, lists/tables of practitioners and their associated data (e.g., address information), identified regional and/or national opinion leaders, reporters generated from the survey information, web page files, and the like. The survey database 128 can incorporate any of a variety of languages and concepts, such as a Simple Query Language (SQL) or XML Query Language (XQL) relational database management system (RDMS). Exemplary commercial implementations of the database 128 can include, for example, the Adaptive Service Enterprise 12.5 available from Sybase, Inc. of Dublin, Calif.; SQL Server 2000 available from Microsoft Corp. of Redmond, Wash.; Oracle 9i Database available from Oracle Corporation of Redwood Shores, Calif.; and Informix and DB2, both available from International Business Machines Corporation of Armonk, N.Y.

In at least one embodiment, a record entry 1010 is maintained in the database 128 for each identified medical practitioner, whether a survey participant, identified opinion leader, or both. In the illustrated embodiment, the exemplary record entry 1010 includes a number of fields, such as a practitioner identifier (PID) field 1012, a national count field 1014, a regional count 1016, a name field 1018, an institution field 1020, and the like.

Since a number of practitioners may have similar information (such as a same or similar first and/or last name, a same work address, or a same institution), there is the potential that practitioners could be misidentified based on this commonality of information. Accordingly, the PID field 1012 can be used to store a PID that is unique to each practitioner. The national count field 1014 and regional count field 1016 are used to represent the number of survey participants who identified the practitioner associated with the record entry 1010 as a national opinion leader and a regional opinion leader, respectively. For the purposes of explanation, it is assumed that a national opinion leader is not automatically a regional opinion leader unless also explicitly identified as a regional opinion leader. The name field 1018 is used to identify the name of the practitioner of the record entry 1010. The name field 1018 can include a number of subfields for the first name, middle name, last name, name suffix, and the like. The institution field 1020 is used to identify the institution associated with the practitioner of the record entry 1010.

The number of fields associated with the exemplary record entry 1010 has been limited to those listed above for ease of illustration. Those skilled in the art can, using the guidelines provided herein, utilize a record entry having additional and/or different information fields. For example, the record entry 1010 can include fields for those information elements discussed previously, such as fields for a phone number, an e-mail address, a survey submission data (for survey participants), fields for address information, fields for identifying a medical specialty and/or subspecialty, a region field identifying a region associated with the practitioner, and the like.

In one embodiment, the record entry 1010 includes, or has references to, one or more tables 1022, 1028, 1036, 1040 for identifying those survey participants, if any, who have identified the practitioner as a regional and/or national opinion leader, as well as for identifying the practitioners identified by the practitioner of the record entry 1010 as regional and/or local opinion leaders. To illustrate, if the practitioner of the record entry 1010 is a survey participant, the table 1022 can include one or more entries for those practitioners identified by the practitioner of the record entry 1010 as regional opinion leaders (e.g., entries 1024, 1026). Table 1028 could include one or more entries for those practitioners identified by the practitioner of record entry 1010 as national opinion leaders (e.g., entries 1030-1034). The table 1036 can include entries for those survey participants who have identified the practitioner of the record entry 1010 as a regional opinion leader (e.g., entry 1038). Table 1040 can include one or more entries for survey participants who have identified the practitioner of the record entry 1010 as a national opinion leader (e.g., entry 1042). Each entry of the tables 1022, 1028, 1036, and 1040 includes one or more fields of information for the associated participant/survey participant, such as a name field. Each table entry also preferably includes a PID field, allowing the KOL system 120 to quickly and accurately locate the record entry associated with an entry referenced in one or more of the tables.

When a survey response 1048 is received by/input to the KOL system 120 from a survey participant, the KOL system 120 can be adapted to modify any affected record entries as appropriate. To illustrate, references to the record entries of the practitioners identified as opinion leaders by a survey participant are added to the tables 1022 and/or 1028. Further, a reference to the record entry of the survey participant is added to the tables 1036, 1040 of the record entries of the practitioners identified as opinion leaders. When a practitioner is identified as a regional or national opinion leader by the survey response 1048, the national count field 1014 and/or the regional count field 1016 are incremented. The information fields 1018 and 1020 of the record entry of the survey participant are updated based on the information provided by the survey response 1048. When the survey response includes one or more previously unidentified practitioners, the KOL system 120 can be adapted to create a record entry 1010 for each unidentified practitioner and populate the appropriate fields of the record entry 1010 based on the information provided by the survey response 1048.

Referring now to FIG. 11, an exemplary system 1100 for providing survey response information to interested parties via a website is illustrated in accordance with at least one embodiment of the present invention. The exemplary system 1100 includes one or more network devices 1104 (analogous to the network device 304 of FIG. 3) connected to the KOL system 120 via a network 1106 (analogous to the network 306 of FIG. 3).

In at least one embodiment, the KOL system 120 is adapted to provide a website for use by a report recipient (e.g., pharmaceutical representative 1102) to obtain survey response information for one or more surveys managed by the KOL system 120. The website utilized by the system 300 (FIG. 3) to obtain survey response information preferably is the same or similar website utilized by the system 1100 to provide survey information to the pharmaceutical representative 1102. In this case, an exemplary website 400 is discussed above in greater detail with reference to FIG. 4.

Representations of the web page(s) 1108 utilized by the pharmaceutical representative 1102 to obtain survey response information are transmitted to the network device 1104 for display by a web browser 1110 (analogous to the web browser 310 of FIG. 3) in the form of one or more data files 1112 (or data streams). Input from the pharmaceutical representative 1102 to direct the generation and/or display of the survey response information is provided to the KOL system 120 for processing as, for example, reply data 1114. Using the web page(s) 1108, the pharmaceutical representative 1102 can direct the KOL system 120 to generate one or more reports from the survey response information, such as a relationship graph 122, a map 126, and a table 124. The report(s) then can be transmitted to network device 1104 for display on the web browser 1110, or the report(s) can be transmitted as files for storage to local disk at the network device 1104 and/or for use by one or more software applications at the network device 1104. For example, the opinion leader table 124 could be transmitted as a spreadsheet file for use by a spreadsheet software application.

Referring now to FIG. 12, an exemplary web page 1200 for directing the KOL system 120 (FIG. 11) to generate one or more reports from survey response information is illustrated in accordance with at least one embodiment of the present invention. As noted above, the KOL system 120 can be adapted to generate one or more reports based on a geographic region of the identified opinion leaders, a geographic region of the survey participants, by opinion leader name, etc. In the illustrated embodiment, the web page 1200 (displayed by the web browser 1100) includes an opinion leader region input field 1206 and/or an opinion leader subregion input field 1208 that can be used by a report recipient to limit the generated report to those identified opinion leaders located within a certain region and/or subregion (e.g., a particular metropolitan area within a state). The web page 1200 can also include a participant region input field 1216 and/or a participant subregion input field 1218 that can be used to limit the generated report to those opinion leaders identified by survey participants located within a certain region and/or subregion. A practitioner name input field 1222 can be used by the pharmaceutical representative to locate the record entry (record entry 1010, FIG. 10) of a particular medical practitioner stored in the survey database 128 (FIG. 1).

As noted previously, opinion leaders may be denoted as national opinion leaders, regional opinion leaders, subregion opinion leaders, and the like. The web page 1200 can further include a regional opinion leader selection field 1202 and/or a national opinion leader selection field 1204 that are used to select one or more opinion leader types for inclusion in, or exclusion from, a requested report. The web page 1200 can further include additional or alternative search input fields that can be used to limit or direct the generation of a requested report as appropriate. For example, the web page 1200 could include an institution search input field (not shown) that can be used to limit the resulting report to only those opinion leaders associated with a particular institution or to only those survey participants associated with a particular institution.

As noted above, the report(s) generated from the survey responses can be supplied in a variety of formats, such as maps, graphs, charts, tables, lists, and the like. Accordingly, the web page 1200 can further include a report type input field 1230 wherein a pharmaceutical representative can select one or more report formats. Additional or alternative features of the web page 1200 can be implemented by those skilled in the art using the guidelines provided herein.

After the desired search limitations have been input, the report recipient can initiate the generation of the search using, for example, the search object 1224, whereupon the input limitations are transmitted to the KOL system 120 for use in generating one or more survey reports.

Referring now to FIGS. 13-15, various exemplary report formats are illustrated in accordance with at least one embodiment of the present invention. A report generated by the KOL system 120 can be provided in any of a variety of formats, such as tables, lists, tables, charts, graphs, maps, and the like. As discussed previously, the reports can be presented in a hierarchical format, whereby the report recipient can navigate through multiple layers of information, using, for example, a web browser. Although a number of report formats are illustrated below, other report formats may be implemented without departing from the spirit or the scope of the present invention.

FIG. 13 illustrates an exemplary embodiment of a table 124 that may be generated by the KOL system 120 from survey response information. In the illustrated embodiment, the table 124 includes a plurality of table entries 1302-1314, each corresponding to a separate practitioner. The practitioners listed in the table 124 can be limited to identified opinion leaders, survey participants, or a combination thereof. Alternatively, the table 124 could include a comprehensive list of all practitioners having a record entry in the survey database 128. Each table entry can include a plurality of fields, such as a national count field 1322 and a regional count field 1324 used to indicate the number of survey participants who have identified the corresponding practitioner as a national leader and a regional opinion leader, respectively. Each table entry can further include a PID field 1326 to indicate the unique PID of the corresponding practitioner, a name field 1328 to identify the corresponding practitioner by name, as well as other fields used to provide particular information for the corresponding practitioner, such as an institution field 1330, an address field 1332, a phone number field 1334, an e-mail field 1336, and the like.

The table 124 can be provided to the pharmaceutical representative in any of a variety of ways. In one embodiment, the table 124 is provided as a hardcopy or as a spreadsheet file or database file over the network 1106 (FIG. 11) to the network device 1104 (FIG. 11) used by the pharmaceutical representative. The spreadsheet/database file then can be manipulated by a software application at the network device 1104. In a preferred embodiment, the table 124 is provided to the pharmaceutical representative as one or more web pages 1108 displayed on the web browser 1110 of the network device 1104. In this case, the KOL system 120 can be adapted to sort the table entries of the table 124 by one or more of the fields 1322-1336. For example, the pharmaceutical representative could direct the KOL system 120 to sort and display in descending order the table entries 1302-1314 by national count (national count field 1320). Once displayed in this order, the pharmaceutical representative can quickly identify key opinion leaders by identifying the opinion leaders who are identified most frequently by survey participants. Alternatively, the table entries could be sorted by address to quickly identify those opinion leaders in a particular region. Furthermore, each table entry could be displayed in, for example, a hierarchical format by providing, for example, an HTML hyperlink to the record entry 1010 (FIG. 10) of the corresponding practitioner in the database 128. Accordingly, upon selection of one of the table entries, the KOL system 120 could return the record entry 1010 of the corresponding practitioner for display on the web browser 1110.

FIG. 14 illustrates an exemplary relationship graph 122 for displaying relationships between opinion leaders and/or survey respondents. In the illustrated embodiment, the graph 122 includes a plurality of interconnected graph elements 1410-1438, each graph element corresponding to a different practitioner. Lines between the graph elements indicate relations between practitioners of the graph 122. To illustrate, a directional arrow line can be displayed between the graph element of survey participant and the graph element of another practitioner when the survey participant has identified the other practitioner as an opinion leader. For example, line 1402 can indicate that “Dr. Joseph” (graph element 1420) identified “Dr. Ortega” (graph element 1422) as an opinion leader in a survey response. Likewise, a dotted line between graph elements can be used to indicate that two practitioners have identified each other as opinion leaders. For example, line 1404 can indicate that “Dr. Ortega” (graph element 1422) identified “Dr. Livingston” (graph element 1410) as an opinion leader and that “Dr. Livingston” has identified “Dr. Ortega” as an opinion leader in return. The appearance of the lines can vary to indicate if a practitioner has identified another practitioner as a regional or national opinion leader. For example, lines representing a national opinion leader reference could be displayed as a different color than lines representing a regional opinion leader reference.

In instances where a certain practitioner has no identified relationship with another practitioner, this absence of a relationship can be indicated by an absence of lines projecting from the graph element representing the practitioner. For example, assume that “Dr. Frederick” (graph element 1414) neither identified any of the other practitioners of the graph 122 as opinion leaders nor was “Dr. Frederick” identified by any of the other practitioners as an opinion leader. Accordingly, the graph element 1414 for “Dr. Frederick” can be displayed as an isolated graph element.

Further, in at least one embodiment, the appearance of the graph element associated with a practitioner can vary depending on the number of times the practitioner is identified as an opinion leader by other practitioners. In the illustrated example, the size of the displayed graph element associated with a practitioner is proportional to the number of times the practitioner is identified as an opinion leader by the others. Alternatively, the color, shape, position, etc. of a graph element can be varied depending on the number of opinion leader references to the corresponding practitioner.

In instances wherein the graph 122 is displayed via a web page, the KOL system 120 can be adapted to provide hierarchical information about the corresponding practitioner. For example, the graph 122 can be implemented as a web page, each graph including an HTML hyperlink to the corresponding record entry 1010 in the database 128. A pharmaceutical representative can select a graph element using an input device (e.g., a mouse or keyboard). In response, the KOL system 120 returns the record entry 1010 corresponding to the requested practitioner to the web browser 1100 for display. Rather than providing the graph 122 via the website, the raw data representative of the graph 122 can be supplied to a commercial software application for display of the resulting graph 122. Exemplary software applications adapted to generate various versions of the graph 122 include, but are not limited to: Board Management Information Toolkit (MIT) available from Orenburg Resources, Inc. of San Diego, Calif.; Actuate e.Report Option available from Actuate Corporation of San Francisco, Calif.; Cognos Visualizer Series 7 available from Cognos Incorporated of Ottawa, Canada; and Microstrategy Web Reporter available from Microstrategy, Inc. of McLean, Va.

FIG. 15 illustrates an exemplary implementation of the opinion leader map 126 for displaying the geographical locations of opinion leaders, survey participants, and/or other medical practitioners within an identified region. Using address information obtained from the report entries 1010 (FIG. 10) of a selected subset of the participants, the KOL system 120 (FIG. 11) can be adapted to overlay map elements (e.g., map elements 1502-1506) over a map 1510 of a particular region. The map 126 preferably is displayed via a website supported by the KOL system 120. Alternatively, the KOL system 120 can be adapted to provide raw data to a commercial mapping tool, such as the MapQuest Locator available from MapQuest.com, Inc. of Lancaster, Pa, and the resulting map then can be directly or indirectly provided to the pharmaceutical representative for viewing.

As with the graph elements of the relationship graph 126 of FIG. 14, the appearance of the map elements can be varied to convey information to an observer. For example, the size and/or color of the map elements can vary depending on the number of opinion leader references the corresponding practitioners have received. Similarly, certain features of the map elements can correspond to one or more features of the corresponding practitioner. For example, those practitioners affiliated with hospitals could be represented by cross-shaped map elements, while those practitioners associated with government research centers could be identified by a square map element.

A pharmaceutical representative or other report recipient can use the map 126 to efficiently assess the concentration of opinion leaders within a certain region. For example, the illustrated example indicates a relatively high concentration of highly regarded opinion leaders in two locations of the map. Based on this assessment, the pharmaceutical representatives can focus their marketing efforts on one or both of these regions. As a result, the expense of marketing in other regions that are relatively devoid of influential opinion leaders can be minimized by a quick analysis of the map 126.

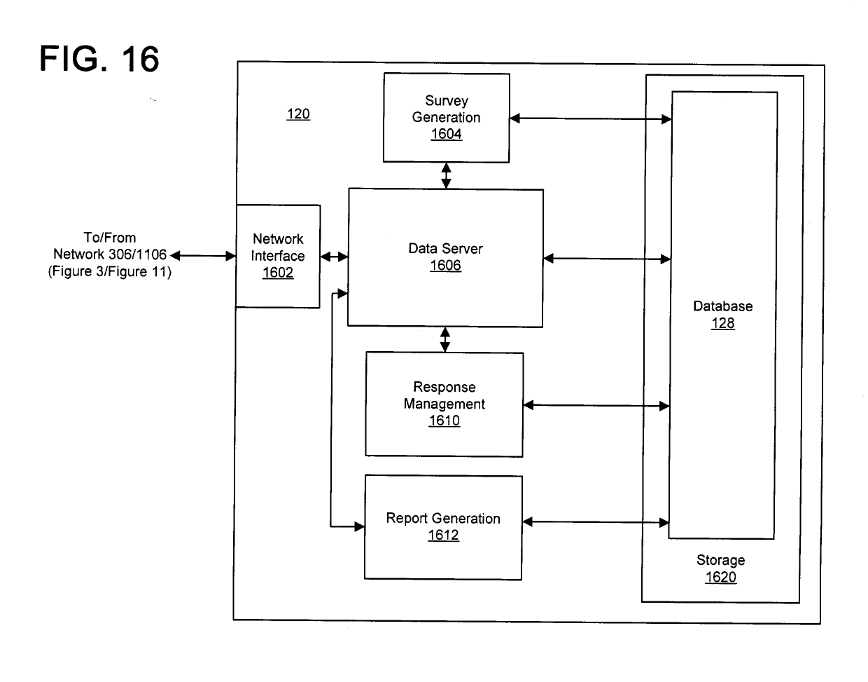

Referring now to FIG. 16, an exemplary implementation of the KOL system 120 is illustrated in greater detail in accordance with at least one embodiment of the present invention. In the illustrated example, the KOL system 120 includes a network interface 1602, a survey generation module 1604, a data server 1606, a response management module 1610, a report generation module 1612, and storage 1620 for storing the survey database 128. Although the components of the KOL system 120 are illustrated is part of a single device for ease of illustration, the components of the KOL system 120 can be distributed among a plurality of devices without departing from the spirit or the scope of the present invention. For example, the data server 1606 and the database 128 each could be implemented as part of a separate device or groups of devices. The components of the KOL system 120 can be implemented in software, hardware, firmware, or a combination thereof.

In at least one embodiment, the data server 1606 is adapted to provide files representative of the web page(s) of the website supported by the KOL system 120 to one or more network devices, such as network device 304 of FIG. 3 and network device 1104 of FIG. 11, via the network interface 1602. Likewise, the data server 1606 is further adapted to receive information supplied by survey participants and/or pharmaceutical representatives through the web page(s), where the information is received via the network interface 1602. The network interface 1602 can include any of a variety of network interface devices appropriate to the network to which the network interface 1602 is attached, such as an Ethernet interface, a wireless interface, and the like.

The survey generation module 1604, in one embodiment, is adapted to identify potential survey participants from one or more lists stored in the database 128 and to generate a survey for transmission to the identified potential survey participants. The survey generation module 1604 could generate web page(s) representative of the desired survey (e.g., web pages 500-800 of FIGS. 5-8, respectively) and store file(s) representative of the survey web page(s) to the database 128. To illustrate, the survey generation module 1604 could include web-publishing software used by an administrator to generate web pages. Alternatively, the survey generation module 1604 could include an automated software application adapted to generate web pages based on, for example, supplied configuration information. After generating a survey, the survey generation module 1604 could provide an invitation e-mail to the data server 1606 for distribution to a list of e-mail addresses supplied by the survey generation module 1604 or stored in the database 128. In this case, the data server 1606 can include, for example, a Simple Mail Transfer Protocol (SMTP) server adapted for the transmission and receipt of e-mail. Upon receipt of the invitation e-mail or other form of invitation (e.g., by publication or by telephone request), survey respondents can contact the data server 1606 and via a web browser and request the survey web pages. The data server 1606 can retrieve the file(s) representative of the survey web pages and transmit them to the requesting web browser for display.

The survey participants then may submit survey response information via the supplied survey web page(s) to the data server 1606. The data server 1606 can be adapted to parse the survey response information and provide the information to the response management module 1610. In at least one embodiment, the response management module 1610 is adapted to verify and/or cleanse the survey response information, as discussed above. After cleansing and/or verifying the survey response information, the response management module 1610 is adapted to insert this information into the database 128. To insert the survey response information into the database 128, the response management module 1610 can be adapted to access those record entries 1010 (FIG. 10) affected by the survey response information and add, modify, and/or delete information stored in the record entries 1010 based on the survey response information. Additionally, if the survey response information includes information regarding an unlisted practitioner(s), the response generation module 1610 can be adapted to create new record entries 1010 or the unlisted practitioner(s).

As noted above, the KOL system 120 also can be adapted to generate reports from the survey response information received from survey participants. In this case, the data server 1606 can provide one or more web pages for display on a web browser used by a pharmaceutical representative, wherein the web pages can be used by the pharmaceutical representative to direct the KOL system 120 to generate one or more reports of a specified format. Accordingly, the data server 1606 can be adapted to parse the report generation parameters from a response received from the pharmaceutical representative and provide the report generation parameters to the report generation module 1612.

Using the report generation parameters (e.g., report format, limits as to the type of opinion leaders or geographical location, etc.), the report generation module 1612 is adapted to generate the one or more requested reports using the record entries 1010 in the survey database 128. For example, the report generation module 1612 could include a SQL server adapted to perform various SQL operations on the database 128 to generate the reports, such as searching, collating, sorting, joining, and the like. After generating the requested report(s), the files representative of the report(s) can be stored in the database 128. The data server 1606 then can retrieve the files from the database 128, format them for display as one or more web pages, and provide the web page files for display on the web browser used by the pharmaceutical representative. Alternatively, the data server 1606 could transmit the report files to the pharmaceutical representative using, for example, a File Transfer Protocol (FTP) server or through data sharing or data integration into the pharmaceutical representative's existing system. The data server 1606 or other component of the KOL system 120 could be adapted to provide the report files to a printer. The resulting hardcopy of the report(s) then could be mailed or otherwise delivered to the pharmaceutical representative.

Referring now to FIGS. 17-27, various exemplary web pages of a “community portal” are illustrated in accordance with at least one embodiment of the present invention. The KOL system 120 and the website 400, in one embodiment, are implemented as part of an overall community portal website whereby practitioners can complete surveys, chat with other practitioners on certain topics, join discussion forums on certain topics, view press releases and other articles, obtain pharmaceutical product information and the like. FIG. 17 illustrates an exemplary implementation login web page 402 (FIG. 4) displayed on web browser 1110 whereby a visitor can obtain access to the community portal by providing a user ID in login field 1702 and a password in password field 1704. The visitor can submit the supplied ID and password by selecting, for example, login object 1706 (e.g., a GUI “button”) to direct the web browser 1110 to submit the supplied information for verification. If verified, the browser 1110 is directed to display the main web page 404 (FIG. 4).

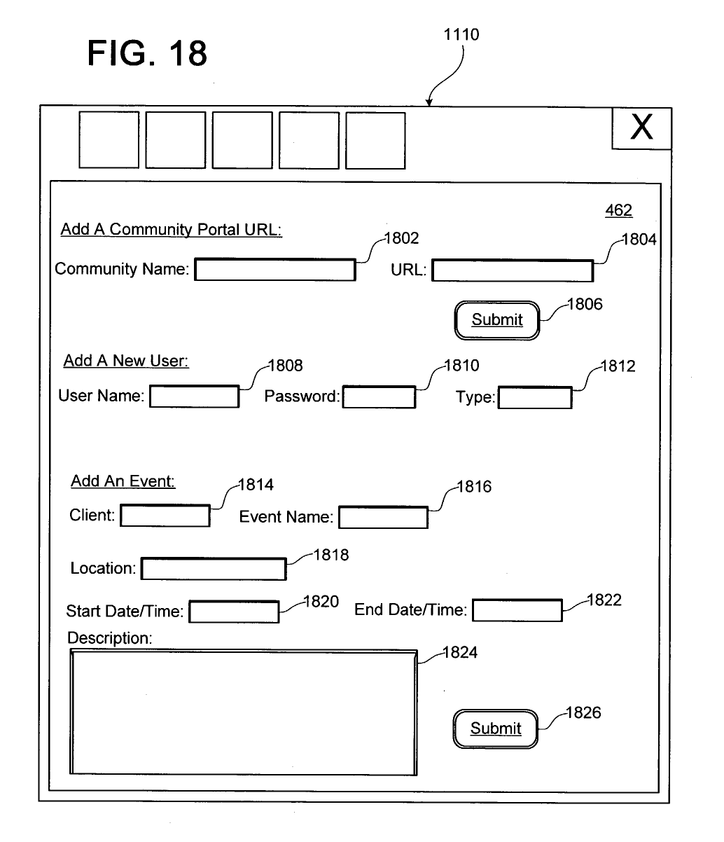

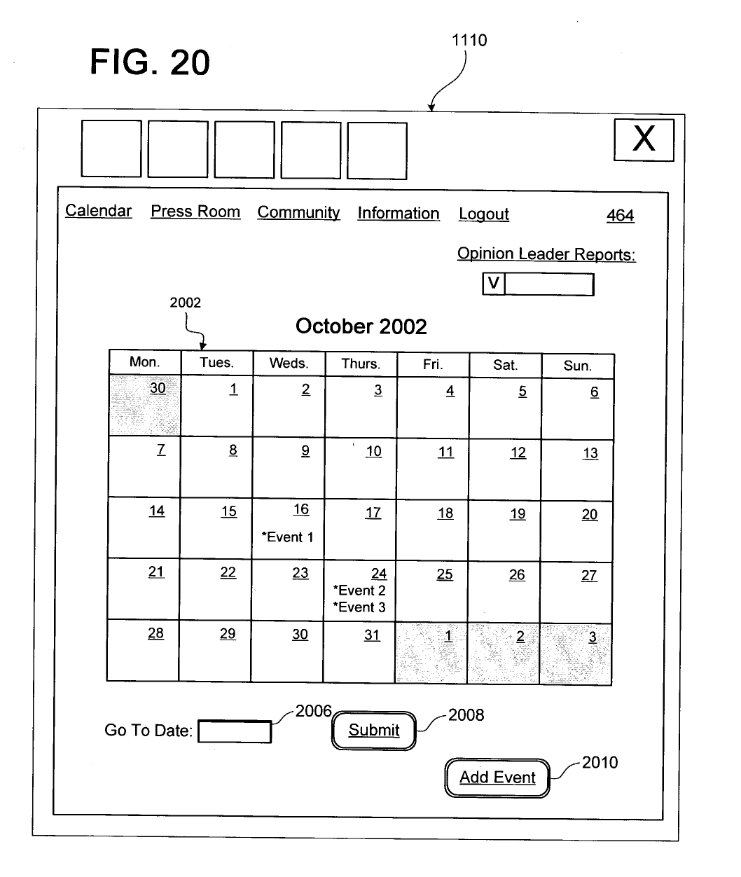

FIG. 18 illustrates an exemplary implementation of the administrative web page 462 (FIG. 4) whereby an administrator of the community portal can administer one or more communities of the website. The web page 462 can be displayed using, for example, web browser 1110. Administrative actions performed via the web page 462 can include, for example, adding a community by supplying a community name in input field 1802 and a Uniform Resource Locator (URL) address in input field 1804 and then selecting the submit object 1806. Similarly, the administrator can add a user by providing a user name to input field 1808, a password to input field 1810, and defining the level of access in input field 1812, and then selecting the submit object 1830. The administrator can add an event to the calendar web page 464 (FIG. 20) by inputting a client identifier into input field 1814, an event name in input field 1816, a location in location field 1818, a start time and/or date in input field 1820, an end time and/or date into input field 1822, and a description of the event into input field 1824. The supplied event info then can be submitted to the KOL system 120 for inclusion into the calendar web page 464 by selecting, for example, submit object 1826.

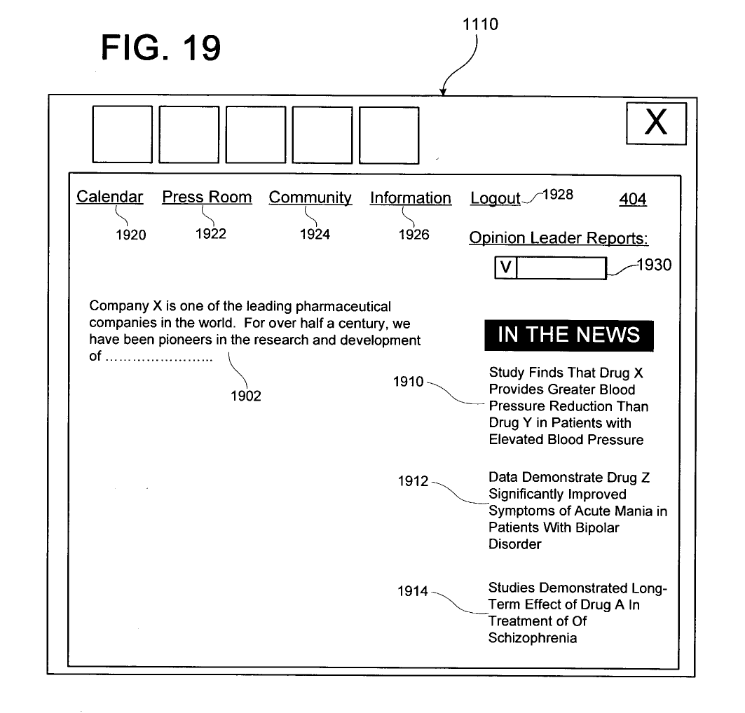

FIG. 19 illustrates an exemplary implementation of the main web page 404 (FIG. 4) associated with a community of the community portal displayed using, for example, web browser 1110. The main web page 404 could be used to display various information about the community, such as information about a pharmaceutical company affiliated with the community in field 1902, information of interest to the visitors of the community in news fields 1910 -1914, as well as links 1920-1928 to other web pages of the community, some of which are described herein. The main web page 404 also can include a link 1930 (e.g., a pull-down list of the opinion leader report types) to the opinion leader survey web page(s) used by a survey participant to complete, edit, or delete surveys, as well as links to report web page(s) used by a report recipient to generate, view, and manipulate one or more reports generated from the survey responses.

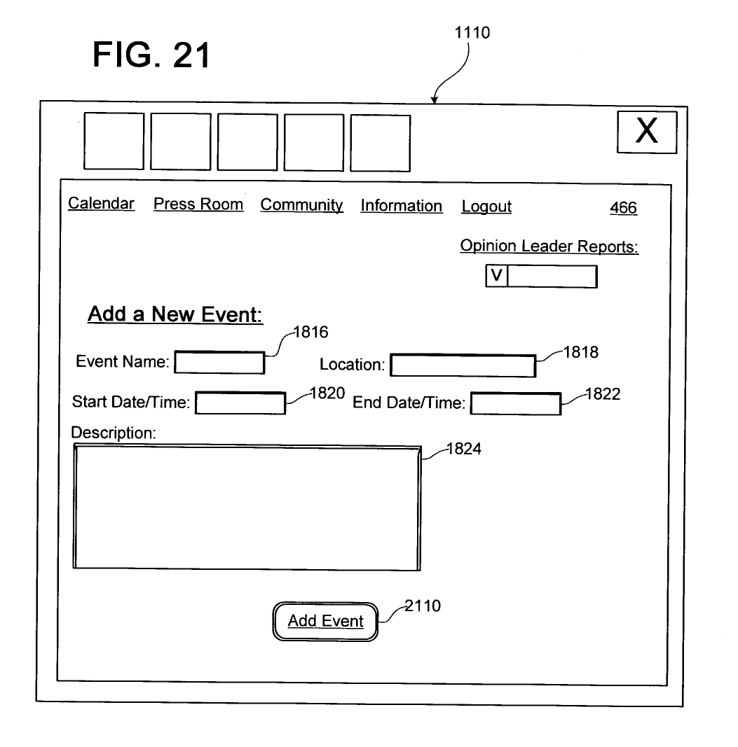

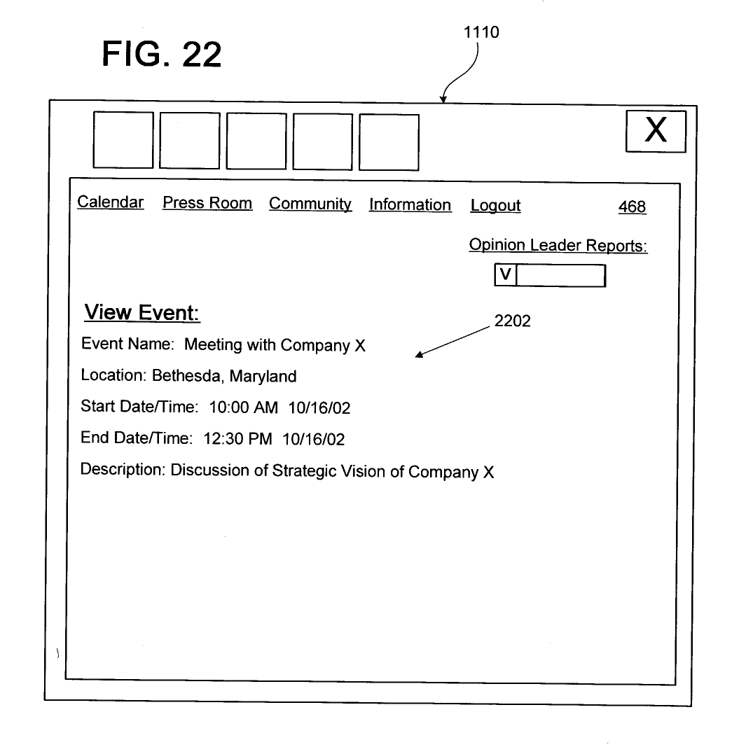

FIG. 20 illustrates an exemplary implementation of the calendar web page 464 (FIG. 4) displayed using, for example, web browser 1110. The calendar web page 464, in one embodiment, includes a calendar display 2002 used to display events in a calendar format, such as monthly, weekly, or daily. Visitors to a community can view upcoming events in the calendar display 2002 by, for example, supplying a date or date range in input field 2006 and selecting the submit object 2008. Further, visitors can view a particular event by, for example, selecting the event title as displayed in the calendar display 2002, where the displayed event title acts as a link to the view event web page 468 (FIG. 22) for the particular event. A visitor can add an event to the calendar display 2002 by, for example, selecting the add event object 2010 which directs the web browser 1110 to display the add event web page 466 (FIG. 21).

FIG. 21 illustrates an exemplary implementation of the add event website 466 (FIG. 4) as displayed on the web browser 1110. The add event website 466 can be used to add one or more events to the calendar display 2002 of the calendar web page 464. To add an event, the visitor can supply an event name in input field 1816, a location in input field 1818, a start date and/or time in field 1820, an end date and/or time in field 1822, and a description in input field 1824. The visitor then may select the add event object 2110 to direct the web browser 1110 to submit the supplied values to the KOL system 120 (FIG. 1) for inclusion in the calendar display 2002.

FIG. 22 illustrates an exemplary implementation of the view event web page 468 (FIG. 4) as displayed by, for example, the web browser 1110. A visitor to the website 400 can utilize the view event web page 468 to view a particular event listed on the calendar web page 464. The information field 2202 associated with the displayed event can include, for example, the event name, the location, the start time and/or date, the end time/date, a description of the event, the attendees, and the like.

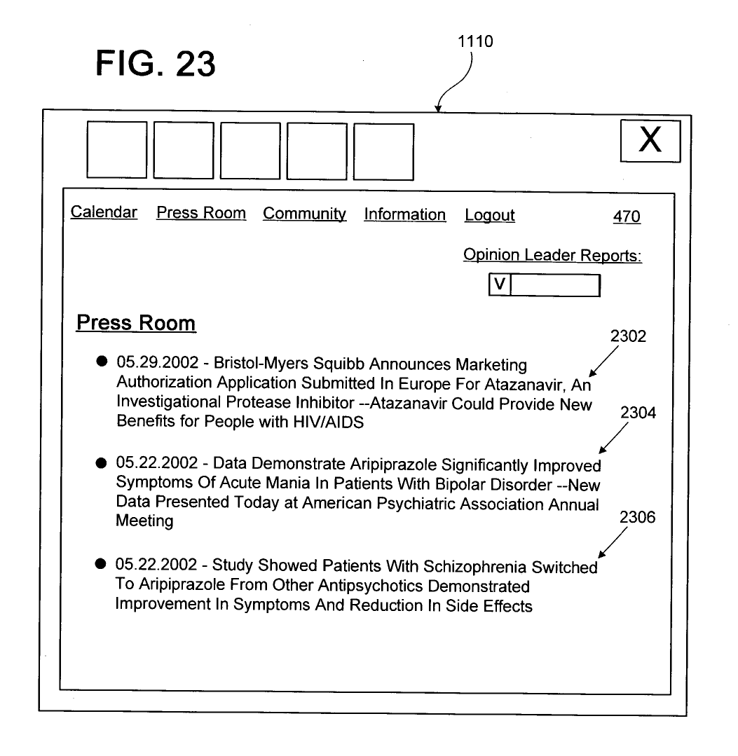

FIG. 23 illustrates an exemplary implementation of the pressroom web page 470 (FIG. 4) as displayed by the web browser 1110. The press room web page 470 can be implemented for providing access to one or more press articles related to the interests of the community members, such as the results of studies on the effects of pharmaceuticals, the awarding of grants, and the like. The exemplary pressroom web page 470 can be adapted display information originating from other sources, such as articles available on other medical-related websites. To illustrate, the press room web page 470 can include abstracts 2302-2306 which provide a brief summary of a press release and which also are adapted to act as a link to the full press release when a visitor selects the text of the abstract. The press release information can be retrieved from another website (e.g., a commercial website), provided by community members, and the like.

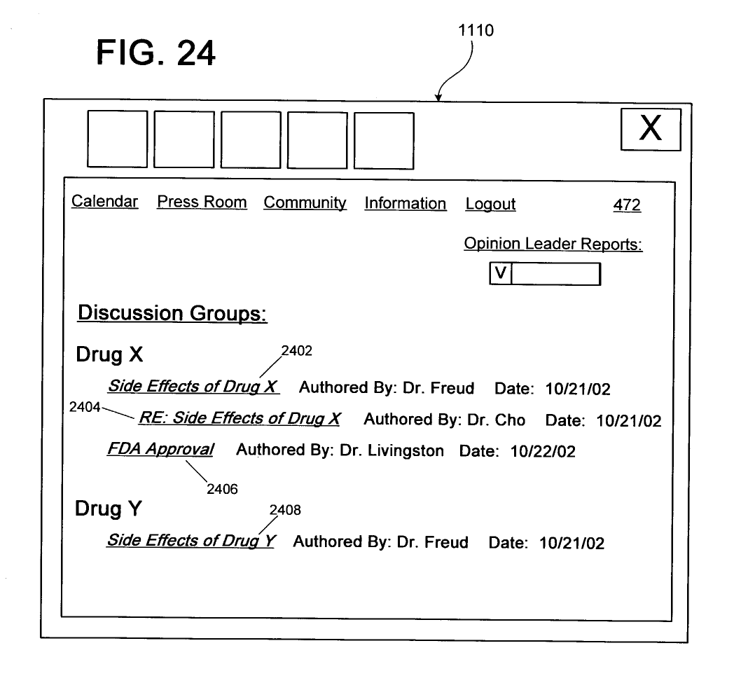

FIG. 24 illustrates an exemplary implementation of the discussion group web page 472 (FIG. 4) as displayed by the web browser 1110. Using the discussion group web page 472, a visitor can view a list of posted discussion messages 2402-2408 provided by other visitors. The posted messages can include new topics, responses to a topic, responses to a response, and the like. A visitor can select a desired posted message and thereby direct the web browser 1110 to obtain the corresponding web page from the KOL system 120 and then display the web page for viewing by the visitor.

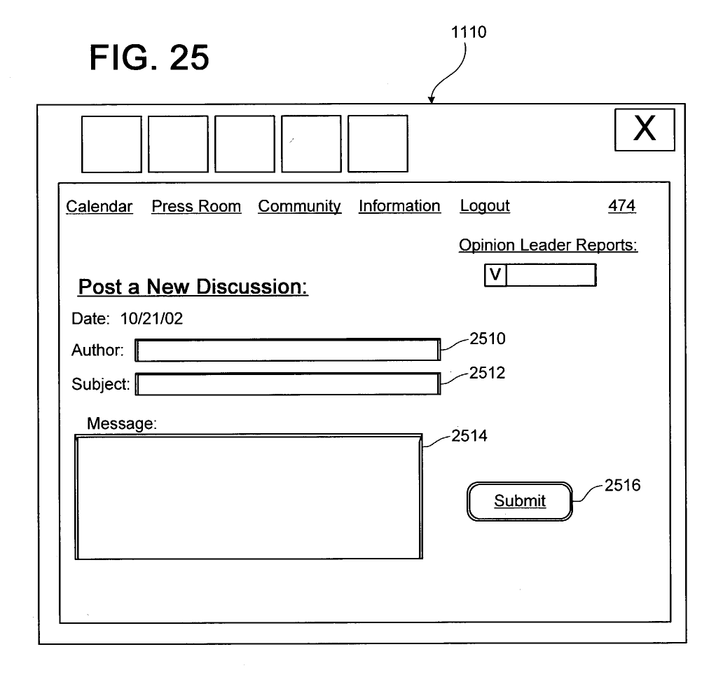

FIG. 25 illustrates an exemplary implementation of the add discussion web page 474 (FIG. 4) displayed using, for example, the web browser 1110. A visitor can use the add discussion web page 474 for adding a discussion message to the desired discussion thread of the discussion group web page 472 (FIG. 24). To add a new discussion or response to a previously posted discussion, the visitor can provide author information in input field 2510, subject information in input field 2512, and the message body in input field 2514. The supplied message then can be submitted to the KOL system 120 for incorporation in the discussion web page 472 when the visitor selects the submit object 2516.

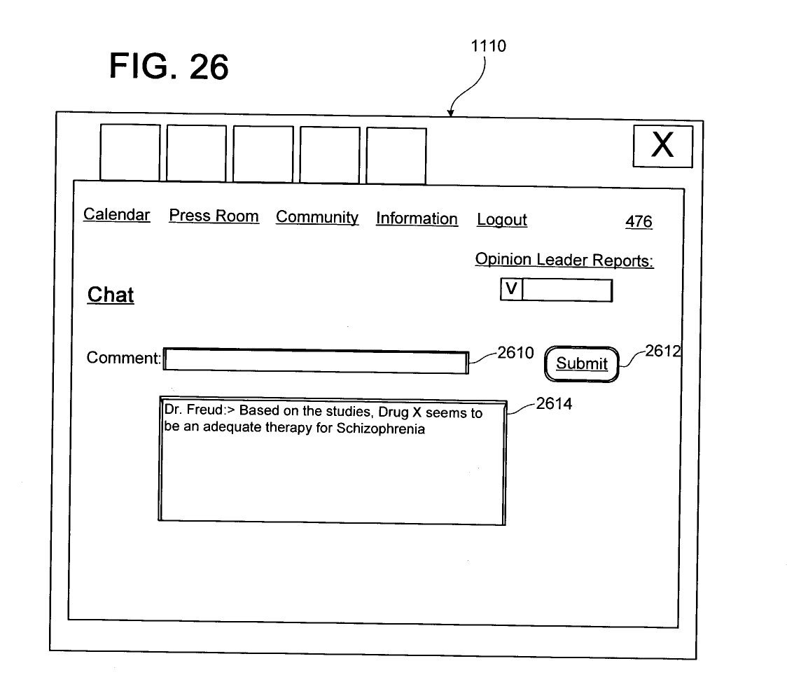

FIG. 26 illustrates an exemplary implementation of the chat web page 476 (FIG. 4) as displayed by the web browser 1110. A visitor can engage another visitor in an online chat by supplying a response or initial comment in the input field 2610 and then selecting the submit object 2612. The visitors comment, as well as other comments from other visitors, is displayed in the display field 2614.

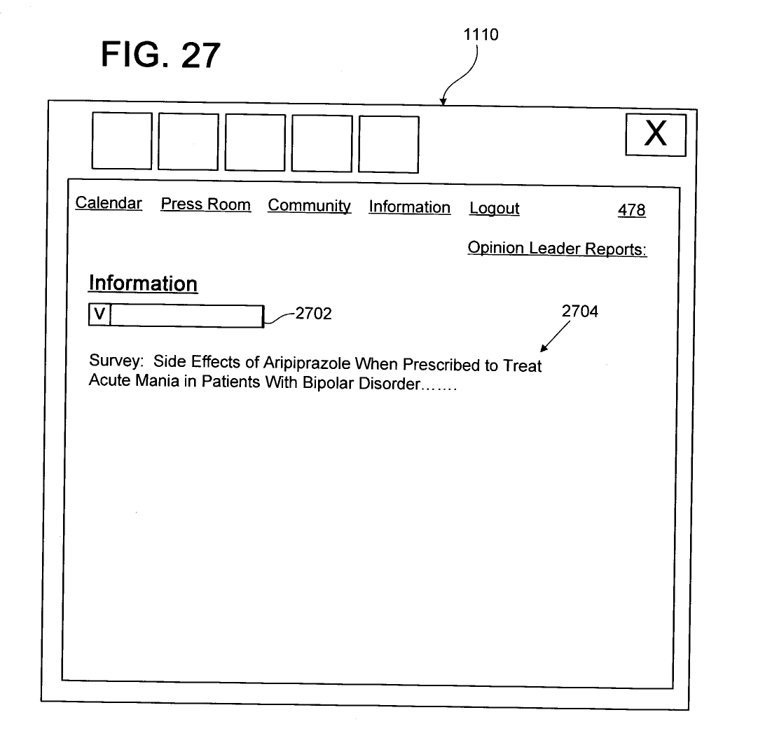

FIG. 27 illustrates an information web page 478 (FIG. 4), displayed using the web browser 1110, whereby a visitor can view information about various topics of interest, such as clinical data, drug details, survey response information, treatment guidelines for illnesses, information about certain patients, as well as slide collections. In the illustrated embodiment, the visitor can select one or more topics or classifications (e.g., treatment guidelines, drug details, clinical data, etc.) in the selection field 2702 to direct the web browser 1110 to display the desired information in one or more display fields 2704. The displayed information may be obtained from the KOL system 120 or an external website or other data source. In at least one embodiment, the information web page 478 may be utilized by medical practitioners to monitor certain pharmaceuticals, such as a certain drugs stage of development (i.e., development stage, clinical trial stage, Food and Drug Administration approval phase, etc).

As described above, FIGS. 1-27 illustrate various exemplary systems and methods for opinion leader surveying and report generation. The hardware portions of the system 120 (FIG. 16) may be in the form of a “processing device,” such as a microprocessor, microcontroller, application specific integrated circuit, or a programmable logic controller, for example. Further, various components of the system 120 and/or steps of the exemplary methods described herein may be implemented as a set of executable instructions (i.e., software) executed by a processing component of the system 120. The instructions may be either permanently or temporarily stored in memory of the system 120. The set of instructions may include various instructions that perform a particular task or tasks, such as those tasks described above with reference to the exemplary methods. Such a set of instructions for performing a particular task may be characterized as a program, software program, or simply software. The software may be in the form of, for example, system software or application software. The software might also be in the form of a collection of separate programs, a program module within a larger program, or a portion of a program module. The software used might also include modular programming in the form of object-oriented programming.

Further, it is appreciated that the instructions or set of instructions used in the implementation and operation of the invention may be in a suitable form such that a processor or other processing component may read the instructions. For example, the instructions that form a program may be in the form of a suitable programming language, which is converted to machine language or object code to allow the processing component to perform the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof

What is claimed is:

1. A method for obtaining opinion leader information, the method comprising the steps of:
providing an opinion leader survey to a plurality of survey participants;
receiving a survey response from each of a subset of the survey participants, the survey response identifying one or more opinion leaders; and
generating at least one report based in part on the survey responses, the at least one opinion leader report including a hierarchical format.

2. The method of claim 1, wherein the step of providing the opinion leader survey includes providing the opinion leader survey in an electronic form.

3. The method of claim 2, wherein the electronic form can include one of a group consisting of:
an e-mail sent to an e-mail address associated with the survey participant and at least one web page displayed to the survey participant.

4. The method of claim 1, further comprising the step of inviting each of the plurality of survey participants to participate in the survey.

5. The method of claim 4, wherein the step of inviting a survey participant includes one of a group consisting of: sending an invitation e-mail to an e-mail address associated with the survey participant; faxing an invitation to a facsimile number associated with the survey participant; publishing an invitation in a publication; and inviting the survey participant by telephone.

6. The method of claim 1, wherein the step of receiving the survey response includes receiving the survey response via an e-mail message.

7. The method of claim 1, wherein the step of receiving a survey response from a survey participant includes receiving the survey response via a web page accessed by the survey participant.

8. The method of claim 1, further comprising the step of providing the at least one report to a report recipient.

9. The method of claim 8, wherein the at least one report is provided in an electronic form.

10. The method of claim 9, wherein the at least one report is provided for display on at least one web page accessed by the report recipient.

11. The method of claim 8, wherein the at least one report is transmitted to the report recipient via a network.

12. The method of claim 1, further comprising the step of verifying information provided with the survey response.

13. The method of claim 1, wherein the at least one report includes one of a group consisting of:
a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

14. The method of claim 1, wherein the survey participants and the identified opinion leaders include medical practitioners.

15. A method for obtaining opinion leader information via a network, the method comprising the steps of:
providing a website for access by a plurality of survey participants via a network, the website including at least one web page representing an opinion leader survey;
receiving a survey response from each of a subset of the survey participants via the at least one web page of the website, the survey response including information identifying one or more opinion leaders; and
generating at least one opinion leader report based in part on the survey responses received via the website.

16. The method of claim 15, further comprising the step of inviting each of the plurality of survey participants to participate, using the website, in the opinion leader survey.

17. The method of claim 16, wherein the step of inviting each of the plurality of survey participants includes one of a group consisting of: sending an invitation e-mail to an e-mail address associated with the survey participant; mailing an invitation to an address associated with the survey participant; faxing an invitation to a facsimile number associated with the survey participant; publishing an invitation in a publication; and inviting the survey participant via telephone.

18. The method of claim 16, further comprising the step of selecting the plurality of survey participants from a plurality of potential survey participants.

19. The method of claim 16, further comprising the step of verifying information associated with a survey participant for at least a subset of the plurality of survey participants.

20. The method of claim 15, further comprising the step of verifying the information of the survey response.

21. The method of claim 15, wherein the at least one web page representing the opinion leader survey includes:
a web page for obtaining information about a survey participant; and
a web page for identifying one or more opinion leaders.

22. The method of claim 21, wherein the step of receiving the survey response from the survey participant via the website includes the steps of:
receiving information about the survey participant; and
receiving information identifying one or more opinion leaders.

23. The method of claim 15, further comprising the step of providing the at least one report to at least one report recipient.

24. The method of claim 23, wherein the step of providing the at least one report includes providing access to the at least one report via the website.

25. The method of claim 24, wherein the at least one report is retrieved in an electronic form from the website.

26. The method of claim 24, wherein the at least one report is displayed on at least one web page of the website.

27. The method of claim 15, wherein the at least one report is generated based in part on input received from a report recipient, the input representing at least one desired limitation on the survey response information used to generate the at least one report.

28. The method of claim 27, wherein the at least one desired limitation is one of a group consisting of: a geographical region for opinion leaders; a geographical region for survey participants; a type of opinion leader; a name; and an institution.

29. The method of claim 15, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

30. The method of claim 15, wherein the survey participants and the identified opinion leaders include medical practitioners.

31. A method for providing survey response information, the method comprising the steps of:
generating at least one report based in part on survey responses received from a plurality of survey participants, each survey response including information identifying one or more opinion leaders from a perspective of the corresponding survey participant; and
providing the at least one report for display on at least one web page of a website.

32. The method of claim 31, wherein the step of providing the at least one report for display includes transmitting data representative of the at least one report to a web browser for display as a web page.

33. The method of claim 31, wherein the at least one report is generated based in part on input received from a report recipient, the input representing at least one desired limitation on the survey response information used to generate the at least one report.

34. The method of claim 33, wherein the at least one desired limitation is one of a group consisting of: a geographical region for opinion leaders; a geographical region for survey participants; a type of opinion leader; a name; and an institution.

35. The method of claim 33, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

36. The method of claim 31, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

37. The method of claim 31, wherein the survey participants and the identified opinion leaders include medical practitioners.

38. A system for automated opinion leader surveying, the system comprising:
a database;
a data server operably connected to the database and being adapted to:
provide, to a plurality of survey participants, data for display as at least one web page, the at least one web page representing an opinion leader survey; and
receive, via the at least one displayed web page, a survey response from each of a subset of the survey participants, the survey response including information identifying one or more opinion leaders;
a response management module operably connected to the database and the data server and being adapted to store a representation of each survey response in the database; and
a report generation module operably connected to the database and being adapted to generate at least one report based in part on the stored representations of the survey responses.

39. The system of claim 38, wherein the data server is further adapted to provide, to each of the plurality of survey participants, an invitation to participate in the opinion leader survey.

40. The system of claim 39, wherein the invitation includes an e-mail invitation addressed to an e-mail address associated with the corresponding survey participant.

41. The system of claim 38, wherein the at least one web page includes at least one input field adapted to receive information about the survey participant.

42. The system of claim 38, wherein the at least one web page includes at least one input field adapted to receive information to identify at least one opinion leader.

43. The system of claim 38, wherein the survey response module is further adapted to, for each survey response, verify the information of the survey response.

44. The system of claim 38, wherein the data server is further adapted to provide data representative of at the at least one report to a report recipient for display as at least one web page.

45. The system of claim 44, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

46. The system of claim 38, wherein the report generation module is further adapted to generate the at least one report based in part on input received from a report recipient, the input representing at least one desired limitation on the survey response information used to generate the at least one report.

47. The system of claim 46, wherein the at least one desired limitation is one of a group consisting of: a geographical region for opinion leaders; a geographical region for survey participants; a type of opinion leader; a name; and an institution.

48. The system of claim 46, wherein the input is received by the data server via a web page.

49. The system of claim 38, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

50. The system of claim 38, further comprising a survey generation module operably connected to the data server and being adapted to generate the at least one web page representative of the opinion leader survey.

51. The system of claim 38, wherein the survey participants and the identified opinion leaders include medical practitioners.

52. A system for automated opinion leader surveying using a network, the system comprising:
a report generation module being adapted to generate at least one report based in part on at least one survey responses to an opinion leader survey, the survey response including information identifying at least one opinion leader;
a data server operably connected to the report generation module and being adapted to provide, to at least one report recipient, data for display as at least one web page, the at least one web page representing the at least one report.

53. The system of claim 52, wherein the report generation module is further adapted to generate the at least one report based in part on input received from a report recipient, the input representing at least one desired limitation on the survey response information used to generate the at least one report.

54. The system of claim 53, wherein the at least one desired limitation is one of a group consisting of: a geographical region for opinion leaders; a geographical region for survey participants; a type of opinion leader; a name; and an institution.

55. The system of claim 53, wherein the input is received by the data server via a web page.

56. The system of claim 52, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

57. The system of claim 52, wherein the survey participants and the identified opinion leaders include medical practitioners.

58. A computer readable medium, the computer readable medium comprising a set of instructions being adapted to manipulate a processor to:
provide a website for access by a plurality of survey participants via a network, the website including at least one web page representing an opinion leader survey;
receive a survey response from each of a subset of the survey participants via the at least one web page of the website, the survey response including information identifying one or more opinion leaders; and
generate at least one opinion leader report based in part on the survey responses received via the website.

59. The computer readable medium of claim 58, further comprising instructions to manipulate the processor to sending an e-mail invitation to each of the plurality of survey participants, the invitation e-mail inviting the survey participants to participate in the opinion leader survey using the website.

60. The computer readable medium of claim 58, further comprising instructions adapted to manipulate the processor to verify information associated with a survey participant for at least a subset of the plurality of survey participants.

61. The computer readable medium of claim 58, further comprising instructions adapted to manipulate the processor to verifying the information of the survey response.

62. The computer readable medium of claim 58, wherein the at least one web page representing the opinion leader survey includes:
a web page for obtaining information about a survey participant; and
a web page for identifying one or more opinion leaders.

63. The computer readable medium of claim 58, further comprising instructions adapted to manipulate the processor to provide the at least one report to at least one report recipient.

64. The computer readable medium of claim 63, wherein instructions for providing the at least one report include instructions adapted to manipulate the processor to provide access to the at least one report via the website.

65. The computer readable medium of claim 64, wherein the at least one report is displayed on at least one web page of the website.

66. The computer readable medium of claim 58, wherein the at least one report is generated based in part on input received from a report recipient, the input representing at least one desired limitation on the survey response information used to generate the at least one report.

67. The computer readable medium of claim 66, wherein the at least one desired limitation is one of a group consisting of: a geographical region for opinion leaders; a geographical region for survey participants; a type of opinion leader; a name; and an institution.

68. The computer readable medium of claim 58, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

69. The computer readable medium of claim 58, wherein the survey participants and the identified opinion leaders include medical practitioners.

70. The computer readable medium of claim 69, wherein the website includes a webpage for displaying information regarding one or more pharmaceuticals.

71. A computer readable medium, the computer readable medium comprising a set of instructions being adapted to manipulate a processor to:
generate at least one report based in part on survey responses received from a plurality of survey participants of an opinion leader survey, each survey response including information identifying one or more opinion leaders from a perspective of the corresponding survey participant; and
provide the at least one report for display on at least one web page of a website.

72. The computer readable medium of claim 71, wherein the instructions for providing the at least one report for display include instructions adapted to manipulate the processor to transmit data representative of the at least one report to a web browser for display as a web page.

73. The computer readable medium of claim 71, wherein the at least one report is generated based in part on input received from a report recipient, the input representing at least one desired limitation on the survey response information used to generate the at least one report.

74. The computer readable medium of claim 73, wherein the at least one desired limitation is one of a group consisting of: a geographical region for opinion leaders; a geographical region for survey participants; a type of opinion leader; a name; and an institution.

75. The computer readable medium of claim 73, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

76. The computer readable medium of claim 71, wherein the at least one report includes one of a group consisting of: a table of opinion leaders; a table of survey participants; a table of opinion leaders and survey participants; a relationship graph of opinion leaders; a relationship graph of survey participants; a relationship graph of opinion leaders and survey participants; a map of locations of a subset of opinion leaders; a map of locations of a subset of survey participants; and a map of locations of a subset of opinion leaders and a subset of survey participants.

77. The computer readable medium of claim 71, wherein the survey participants and the identified opinion leaders include medical practitioners.
